(19) United States
(12) Patent Application Publication
(10) Pub. No.: US 2025/0220732 A1
(43) Pub. Date: Jul. 3, 2025

(54) HUMAN-POWERED VEHICLE COMPONENT, HUMAN-POWERED VEHICLE CONTROL SYSTEM, AND NON-TRANSITORY COMPUTER-READABLE STORAGE MEDIUM

(71) Applicant: SHIMANO INC., Sakai City (JP)

(72) Inventors: Hiroshi MATSUDA, Sakai City (JP); Tomohiro TAKIMOTO, Sakai City (JP); Akihiro NOZAKI, Sakai City (JP)

(73) Assignee: SHIMANO INC., Sakai City (JP)

(21) Appl. No.: 18/398,129

(22) Filed: Dec. 27, 2023

(51) Int. Cl. H04W 76/10; B62J 45/20; B62M 6/00

(52) U.S. Cl. CPC H04W 76/10; B62J 45/20; B62M 6/00

(57) ABSTRACT

A human-powered vehicle component comprises first wireless communicator circuitry and first electronic controller circuitry. The first wireless communicator circuitry is configured to wirelessly receive a pairing trigger signal generated in response to a user trigger input of a trigger input device. The trigger input device includes a display. The first electronic controller circuitry is configured to cause the human-powered vehicle component to enter a first pairing mode in response to the pairing trigger signal.

### BACKGROUND

### Technical Field

The present invention relates to a human-powered vehicle component, a human-powered vehicle control system, and a non-transitory computer-readable storage medium.

### Background Information

In recent years, some human-powered vehicles are provided with electric components or devices to make it easier for the rider to operate the human-powered vehicle. Typically, each the electric components is operated by an operating devices that interconnects the operating device to the electric component. In more recent years, control systems exist that wirelessly interconnect the electric components to the operating devices. One of objects of the present disclosure is to make it easy to start a pairing process executed between at least two of electric components.

### SUMMARY

In accordance with a first aspect of the present invention, a human-powered vehicle component comprises first wireless communicator circuitry and first electronic controller circuitry. The first wireless communicator circuitry is configured to wirelessly receive a pairing trigger signal generated in response to a user trigger input of a trigger input device. The trigger input device includes a display. The first electronic controller circuitry is configured to cause the human-powered vehicle component to enter a first pairing mode in response to the pairing trigger signal.

With the human-powered vehicle component according to the first aspect, the first electronic controller circuitry is configured to cause the human-powered vehicle component to enter the first pairing mode using the pairing trigger signal wirelessly received by the first wireless communicator circuitry. Thus, it is possible to remotely control the human-powered vehicle component to enter the first pairing mode without an input device provided to the human-powered vehicle component, making it easy to start the pairing process executed between the human-powered vehicle component and another human-powered vehicle component.

In accordance with a second aspect of the present invention, the human-powered vehicle component according to the first aspect is configured so that the first wireless communicator circuitry is configured to wirelessly receive, in the first pairing mode, a first pairing request signal generated in response to a first user input of a first input device. The first electronic controller circuitry is configured to establish, in the first pairing mode, wireless communication between the human-powered vehicle component and a first remote component that sent the first pairing request signal.

With the human-powered vehicle component according to the second aspect, the pairing process can be easily started between the human-powered vehicle component and the first remote component. Thus, it is possible to make it easier to start the pairing process executed between the human-powered vehicle component and another human-powered vehicle component including the first remote component.

In accordance with a third aspect of the present invention, the human-powered vehicle component according to the first or second aspect is configured so that the trigger input device has a function other than a function relating to the human-powered vehicle.

With the human-powered vehicle component according to the third aspect, it is possible to improve the usability of the human-powered vehicle in the pairing process using the trigger input device.

In accordance with a fourth aspect of the present invention, the human-powered vehicle component according to any one of the first to third aspects is configured so that the trigger input device is provided separately from at least one of the first remote component and the first input device.

With the human-powered vehicle component according to the fourth aspect, it is possible to improve the flexibility of usage of the trigger input device compared to a case where the trigger input device is provided integrally with at least one of the first remote component and the first input device.

In accordance with a fifth aspect of the present invention, the human-powered vehicle component according to any one of the first to fourth aspects is configured so that the trigger input device includes at least one of the first remote component and the first input device.

With the human-powered vehicle component according to the fifth aspect, it is possible to simplify a system of the human-powered vehicle.

In accordance with a sixth aspect of the present invention, the human-powered vehicle component according to any one of the first to fifth aspects is configured so that the pairing trigger signal is distinguishable from the first pairing request signal.

With the human-powered vehicle component according to the sixth aspect, it is possible to reliably execute the pairing process.

In accordance with a seventh aspect of the present invention, the human-powered vehicle component according to any one of the first to sixth aspects is configured so that the first wireless communicator circuitry is configured to wirelessly transmit a first pairing response signal in response to the first pairing request signal.

With the human-powered vehicle component according to the seventh aspect, it is possible to execute the pairing process more reliably.

In accordance with an eighth aspect of the present invention, the human-powered vehicle component according to the seventh aspect is configured so that the first wireless communicator circuitry is configured to automatically transmit the first pairing response signal in response to the first pairing request signal.

With the human-powered vehicle component according to the eighth aspect, it is possible to smoothly execute the pairing process.

In accordance with a ninth aspect of the present invention, the human-powered vehicle component according to the seventh or eighth aspect is configured so that further comprise a user interface configured to receive a user operation. The first wireless communicator circuitry is configured to transmit the first pairing response signal in response to the user operation in a state where the first wireless communicator circuitry receives the first pairing request signal.

With the human-powered vehicle component according to the ninth aspect, the user can control the timing at which the first pairing response signal is transmitted after the receipt of the first pairing request signal. Thus, it is possible to reliably proceed the pairing process.

In accordance with a tenth aspect of the present invention, the human-powered vehicle component according to any one of the seventh to ninth aspects is configured so that the first wireless communicator circuitry is configured to receive a first pairing signal from the first remote component. The first pairing signal is generated in response to the first pairing response signal.

With the human-powered vehicle component according to the tenth aspect, it is possible to reliably proceeds the pairing process.

In accordance with an eleventh aspect of the present invention, the human-powered vehicle component according to any one of the first to tenth aspects is configured so that the human-powered vehicle component has a wireless signal listening mode in which the first electronic controller circuitry detects the pairing trigger signal via the first wireless communicator circuitry. The wireless signal listening mode is different from the first pairing mode.

With the human-powered vehicle component according to the eleventh aspect, it is possible to reliably receive the pairing trigger signal in the wireless signal listening mode.

In accordance with a twelfth aspect of the present invention, the human-powered vehicle component according to the eleventh aspect is configured so that the first electronic controller circuitry is configured to cause the human-powered vehicle component to enter the first pairing mode in a case where the first electronic controller circuitry detects the pairing trigger signal via the first wireless communicator circuitry in the wireless signal listening mode.

With the human-powered vehicle component according to the twelfth aspect, it is possible to receive the pairing trigger signal more reliably in the wireless signal listening mode.

In accordance with a thirteenth aspect of the present invention, the human-powered vehicle component according to the eleventh or twelfth aspect is configured so that the first wireless communicator circuitry is configured to wirelessly receive, in the first pairing mode, a first pairing request signal generated in response to a first user input of a first input device. The first electronic controller circuitry is configured to ignore or not detect the first pairing request signal in the wireless signal listening mode.

With the human-powered vehicle component according to the thirteenth aspect, it is possible to receive the pairing trigger signal more reliably in the wireless signal listening mode without responding the first pairing request signal.

In accordance with a fourteenth aspect of the present invention, the human-powered vehicle component according to any one of the eleventh to thirteenth aspects is configured so that the first electronic controller circuitry is configured to cause, in response to a trigger, the human-powered vehicle component to enter the wireless signal listening mode.

With the human-powered vehicle component according to the fourteenth aspect, it is possible to smoothly change the mode of the human-powered vehicle component to the wireless signal listening mode using the trigger.

In accordance with a fifteenth aspect of the present invention, the human-powered vehicle component according to the fourteenth aspect is configured so that the trigger includes at least one of: providing electrical power to the human-powered vehicle component; connecting an electrical power source to the human-powered vehicle component; connecting an electrical cable connected to an additional human-powered vehicle component; operating an additional control device configured to control the additional human-powered vehicle component; and providing an output from a sensor to the human-powered vehicle component.

With the human-powered vehicle component according to the fifteenth aspect, it is possible to change the mode of the human-powered vehicle component more smoothly to the wireless signal listening mode using the trigger.

In accordance with a sixteenth aspect of the present invention, the human-powered vehicle component according to any one of the first to fifteenth aspects is configured so that the trigger input device includes at least one of a smartphone, a tablet computer, a personal computer, a wearable device, and a cycle computer. The first wireless communicator circuitry is configured to wirelessly receive the pairing trigger signal generated in response to the user trigger input received by the at least one of the smartphone, the tablet computer, the personal computer, the wearable device, and the cycle computer.

With the human-powered vehicle component according to the sixteenth aspect, it is possible to use the at least one of the smartphone, the tablet computer, the personal computer, the wearable device, and the cycle computer as the trigger input device, improving the usability of the human-powered vehicle in the pairing process.

In accordance with a seventeenth aspect of the present invention, a human-powered vehicle control system comprises the human-powered vehicle component according to any one of the first to sixteenth aspects and the first remote component.

With the human-powered vehicle control system according to the seventeenth aspect, it is possible to easily start the pairing process executed between the human-powered vehicle component and the first remote component.

In accordance with an eighteenth aspect of the present invention, the human-powered vehicle control system according to the seventeenth aspect further comprises an additional human-powered vehicle component. The additional human-powered vehicle component comprises second wireless communicator circuitry and second electronic controller circuitry. The second wireless communicator circuitry is configured to wirelessly receive the pairing trigger signal generated in response to the user trigger input. The second electronic controller circuitry is configured to cause the additional human-powered vehicle component to enter a second pairing mode in response to the pairing trigger signal.

With the human-powered vehicle control system according to the eighteenth aspect, it is possible to easily start the pairing process executed between the additional human-powered vehicle component and another human-powered vehicle component in addition to the pairing process executed between the human-powered vehicle component and the first remote component.

In accordance with a nineteenth aspect of the present invention, the human-powered vehicle component according to the eighteenth aspect is configured so that the trigger input device is configured to transmit the pairing trigger signal in response to the user trigger input to the human-powered vehicle component and the additional human-powered vehicle component.

With the human-powered vehicle control system according to the nineteenth aspect, it is possible to more easily start the pairing process executed between the additional human-powered vehicle component and another human-powered vehicle component in addition to the pairing process executed between the human-powered vehicle component and the first remote component.

In accordance with a twentieth aspect of the present invention, a human-powered vehicle control system comprises a human-powered vehicle component and an additional human-powered vehicle component. The human-powered vehicle component comprises first wireless communicator circuitry and first electronic controller circuitry. The first wireless communicator circuitry is configured to wirelessly receive a pairing trigger signal generated in response to a user trigger input of a trigger input device. The first electronic controller circuitry is configured to cause the human-powered vehicle component to enter a first pairing mode in response to the pairing trigger signal. The additional human-powered vehicle component comprises second wireless communicator circuitry and second electronic controller circuitry. The second wireless communicator circuitry is configured to wirelessly receive the pairing trigger signal. The second electronic controller circuitry is configured to cause the additional human-powered vehicle component to enter a second pairing mode in response to the pairing trigger signal.

With the human-powered vehicle control system according to the twentieth aspect, it is possible to easily start the pairing process executed between the additional human-powered vehicle component and another human-powered vehicle component in addition to the pairing process executed between the human-powered vehicle component and another human-powered vehicle component.

In accordance with a twenty-first aspect of the present invention, the human-powered vehicle component according to the twentieth aspect is configured so that the first wireless communicator circuitry is configured to wirelessly receive, in the first pairing mode, a first pairing request signal generated in response to a first user input of a first input device. The first electronic controller circuitry is configured to establish, in the first pairing mode, wireless communication between the human-powered vehicle component and a first remote component that sent the first pairing request signal.

With the human-powered vehicle control system according to the twenty-first aspect, the pairing process can be easily started between the human-powered vehicle component and the first remote component. Thus, it is possible to make it easier to start the pairing process executed between the human-powered vehicle component and another human-powered vehicle component including the first remote component.

In accordance with a twenty-second aspect of the present invention, the human-powered vehicle component according to any one of the eighteenth to twenty-first aspects is configured so that the second wireless communicator circuitry is configured to wirelessly receive, in the second pairing mode, a second pairing request signal generated in response to a second user input of a second input device. The second electronic controller circuitry is configured to establish, in the second pairing mode, wireless communication between the additional human-powered vehicle component and a second remote component that sent the second pairing request signal.

With the human-powered vehicle control system according to the twenty-second aspect, the pairing process can be easily started between the additional human-powered vehicle component and the second remote component. Thus, it is possible to make it easier to start the pairing process executed between the additional human-powered vehicle component and another human-powered vehicle component including the second remote component while easily starting the pairing process between the human-powered vehicle component and another human-powered vehicle component including the first remote component.

In accordance with a twenty-third aspect of the present invention, a non-transitory computer-readable storage medium stores program for causing a trigger input device including a display to execute a method comprising: receiving a user trigger input; and transmitting wirelessly, in response to the user trigger input, a pairing trigger signal to cause a human-powered vehicle component to enter a first pairing mode.

With the non-transitory computer-readable storage medium according to the twenty-third aspect, it is possible to cause the trigger input device to execute the method. Accordingly, it is possible to easily start the pairing process executed between the human-powered vehicle component and another human-powered vehicle component.

In accordance with a twenty-fourth aspect of the present invention, the non-transitory computer-readable storage medium according to the twenty-third aspect is configured so that the display includes a touch panel configured to receive the user trigger input. The receiving the user trigger input includes receiving the user trigger input via the touch panel.

With the non-transitory computer-readable storage medium according to the twenty-fourth aspect, the touch panel can improve the usability of the trigger input device.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a side elevational view of a human-powered vehicle including a human-powered vehicle control system including at least two human-powered vehicle components in accordance with one of embodiments.

FIG. 2 is a side elevational view of one of the at least two human-powered vehicle components illustrated in FIG. 1.

FIG. 3 is a side elevational view of another of the at least two human-powered vehicle components illustrated in FIG. 1.

FIG. 4 is a side elevational view of another of the at least two human-powered vehicle components illustrated in FIG. 1.

FIG. 5 is a side elevational view of another of the at least two human-powered vehicle components illustrated in FIG. 1.

FIG. 6 is a side elevational view of another of the at least two human-powered vehicle components illustrated in FIG. 1.

FIG. 7 is a schematic block diagram of the human-powered vehicle control system illustrated in FIG. 1 (paired).

FIG. 8 is a schematic block diagram of the human-powered vehicle control system illustrated in FIG. 1 (paired).

FIG. 9 is a schematic block diagram of the human-powered vehicle control system illustrated in FIG. 1 (pairing).

FIG. 10 is a schematic block diagram of the human-powered vehicle control system illustrated in FIG. 1 (pairing).

FIG. 11 is a schematic block diagram of a human-powered vehicle control system in accordance with a first modification (pairing).

FIG. 12 is a schematic block diagram of a human-powered vehicle control system in accordance with a second modification (pairing).

FIG. 13 is a schematic block diagram of a human-powered vehicle control system in accordance with a second modification (pairing).

FIG. 14 is a flowchart of a control executed in a trigger input device of the human-powered vehicle control system illustrated in FIG. 1.

FIGS. 15 and 16 are flowcharts of a pairing process executed between one of the at least two human-powered vehicle components of the human-powered vehicle control system illustrated in FIG. 1.

FIG. 17 is a flowchart showing a control mode of one of the at least two human-powered vehicle components of the human-powered vehicle control system illustrated in FIG. 1.

FIG. 18 is a schematic block diagram showing the pairing process executed between two of the at least two human-powered vehicle components and between other two of the at least two human-powered vehicle components of the human-powered vehicle control system illustrated in FIG. 1.

FIG. 19 is a schematic block diagram of a human-powered vehicle control system in accordance with a third modification.

FIG. 20 is a schematic block diagram of a human-powered vehicle control system in accordance with a fourth modification.

FIG. 21 is a schematic block diagram of a human-powered vehicle control system in accordance with a fifth modification.

### DESCRIPTION OF THE EMBODIMENTS

The embodiments will now be described with reference to the accompanying drawings, wherein like reference numerals designate corresponding or identical elements throughout the various drawings.

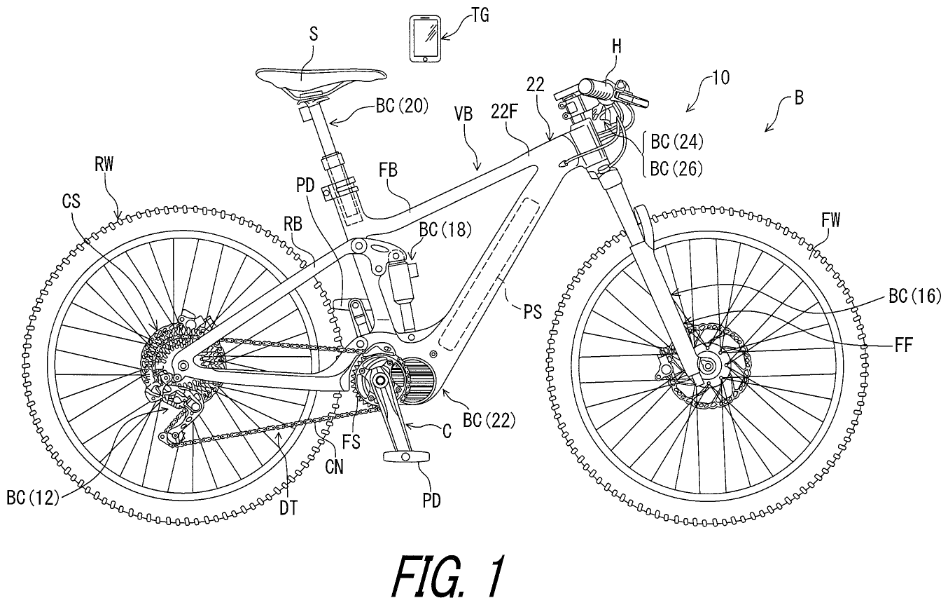

Referring initially to FIG. 1, a human-powered vehicle B includes a human-powered vehicle control system 10 in accordance with one of embodiments. The human-powered vehicle control system 10 includes at least two human-powered vehicle components BC. In the present embodiment, the human-powered vehicle B is illustrated as an e-bike that uses a driving force of an electric motor in addition to a human driving force for propulsion. However, the human-powered vehicle control system 10 can be applied to any other type of human-powered vehicles such as, for example, a mountain bike, a cyclocross bicycle, a gravel bike, a city bike, a cargo bike, and a recumbent bike.

In the present application, the term “human-powered vehicle” includes a vehicle to travel with a motive power including at least a human power of a user who rides the vehicle. The human-powered vehicle includes a various kind of bicycles such as a mountain bike, a road bike, a city bike, a cargo bike, a hand bike, and a recumbent bike. Furthermore, the human-powered vehicle includes an electric bike called as an E-bike. The electric bike includes an electrically assisted bicycle configured to assist propulsion of a vehicle with an electric motor. However, a total number of wheels of the human-powered vehicle is not limited to two. For example, the human-powered vehicle includes a vehicle having one wheel or three or more wheels. Especially, the human-powered vehicle does not include a vehicle that uses only a driving source as motive power. Examples of the driving source include an internal-combustion engine and an electric motor. Generally, a light road vehicle, which includes a vehicle that does not require a driver's license for a public road, is assumed as the human-powered vehicle.

Basically, the human-powered vehicle control system 10 is directed to pairing at least two devices such that the at least two devices can wirelessly communicate with each other. Thus, the term “human-powered vehicle component” as used herein generically refers to all the human-powered vehicle components BC of the human-powered vehicle B that are configured to wirelessly communicate with another one of the human-powered vehicle components BC of the human-powered vehicle B after being paired together. The components or parts of the human-powered vehicle B that cannot wirelessly communicate will not be referred to as “human-powered vehicle component” herein.

As seen in FIG. 1, the human-powered vehicle B includes a vehicle body VB, a wheel FW, and a wheel RW. The wheel FW is rotatably coupled to the vehicle body VB. The wheel RW is rotatably coupled to the vehicle body VB. The vehicle body VB is supported by the wheels FW and RW. The wheel FW can also be referred to as a front wheel FW. The wheel RW can also be referred to as a rear wheel RW.

The vehicle body VB includes a front frame body FB, a rear frame body RB, a handlebar H, and a front fork FF. The rear frame body RB includes a swing arm. The rear frame body RB is movably coupled to the front frame body FB. The rear frame body RB is pivotally coupled to the front frame body FB. The front fork FF is pivotally coupled to the front frame body FB. The handlebar H is coupled to the front fork FF to be pivotable relative to the front frame body FB along with the front fork FF.

The human-powered vehicle B further includes a drivetrain DT. Here, for example, the drivetrain DT is a chain-drive type and includes a crank C, at least one front sprocket FS, at least two rear sprockets CS, a chain CN, and pedals PD. The crank C is rotatably coupled to the vehicle body VB. The at least one front sprocket FS is coupled to the crank C to rotate relative to the vehicle body VB along with the crank C. The rear sprockets CS are provided on a hub of the wheel RW. The chain CN is configured to be engaged with one of the at least one front sprocket FS and one of the at least two rear sprockets CS. The pedals PD are coupled to the crank C. A human driving force is applied to the pedals PD by a rider such that the driving force is transmitted to the wheel RW via the at least one front sprocket FS, the chain CN, and the at least two rear sprockets CS. While the drivetrain DT is illustrated as a chain-drive type of drivetrain, the drivetrain DT can be selected from any type of drivetrain and can be a belt-drive type or a shaft-drive type.

In the present application, the following directional terms “front,” “rear,” “forward,” “rearward,” “left,” “right,” “transverse,” “upward” and “downward” as well as any other similar directional terms refer to those directions which are determined based on the user who is in the user's standard position in the human-powered vehicle B while the user faces toward a handlebar or steering. Examples of the user's standard position include a saddle and a seat. Accordingly, these terms, as utilized to describe the human-powered vehicle control system 10, the human-powered vehicle component BC, or other components, should be interpreted relative to the human-powered vehicle B equipped with the human-powered vehicle control system 10, the human-powered vehicle component BC, or other components as used in an upright riding position on a horizontal surface.

As seen in FIG. 1, the at least two human-powered vehicle components BC includes a gear changer 12, a suspension 16, a suspension 18, an adjustable seatpost 20, and an assist drive unit 22. Namely, the human-powered vehicle B includes the gear changer 12, the suspension 16, the suspension 18, the adjustable seatpost 20, and the assist drive unit 22. The gear changer 12 is configured to be mounted to the vehicle body VB. The suspension 16 is configured to be mounted to the vehicle body VB. The suspension 18 is configured to be mounted to the vehicle body VB. The adjustable seatpost 20 is configured to be mounted to the vehicle body VB. The assist drive unit 22 is configured to be mounted to the vehicle body VB.

As seen in FIG. 1, the gear changer 12 is configured to change a gear ratio of the human-powered vehicle B. The gear ratio is a ratio of a rotational speed of the at least two rear sprockets CS to a rotational speed of the at least one front sprocket FS. The gear changer 12 is configured to shift the chain CN relative to the at least two rear sprockets CS. In the present embodiment, the gear changer 12 includes a rear derailleur. In the present embodiment, the gear changer 12 includes a rear derailleur. However, the gear changer 12 can include another type of gear changer if needed or desired. Examples of another type of gear changer include a front derailleur and an internal-gear hub.

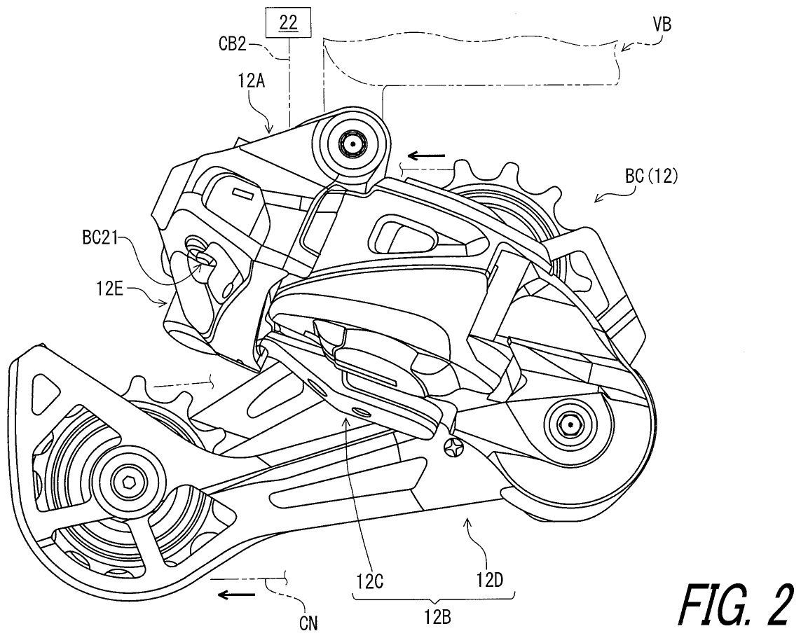

As seen in FIG. 2, the gear changer 12 further comprises a base member 12A and a movable member 12B. The base member 12A is mountable to the vehicle body VB. The movable member 12B is movable relative to the base member 12A. For example, the movable member 12B includes a linkage 12C and a chain guide 12D. The chain guide 12D is contactable with the chain CN. The linkage 12C movably couples the base member 12A and the chain guide 12D.

The gear changer 12 comprises an electric actuator 12E. The electric actuator 12E is configured to generate an actuation force. Examples of the electric actuator 12E include an electric motor. The electric actuator 12E is coupled to at least one of the base member 12A and the movable member 12B to move the movable member 12B relative to the base member 12A. The electric actuator 12E is at least partially provided to at least one of the base member 12A and the movable member 12B. The electric actuator 12E can be configured to be controlled based on a control signal transmitted from another device or to be automatically controlled based on information relating to the human-powered vehicle B.

As seen in FIG. 1, the suspension 16 is configured to absorb or damp shocks or vibrations generated by riding on rough terrain. The suspension 16 is installed in the front fork FF. The suspension 16 and the front fork FF constitute a suspension fork. The suspension 16 is configured to absorb or damp shocks or vibrations transmitted from at least one of the wheels FW and RW.

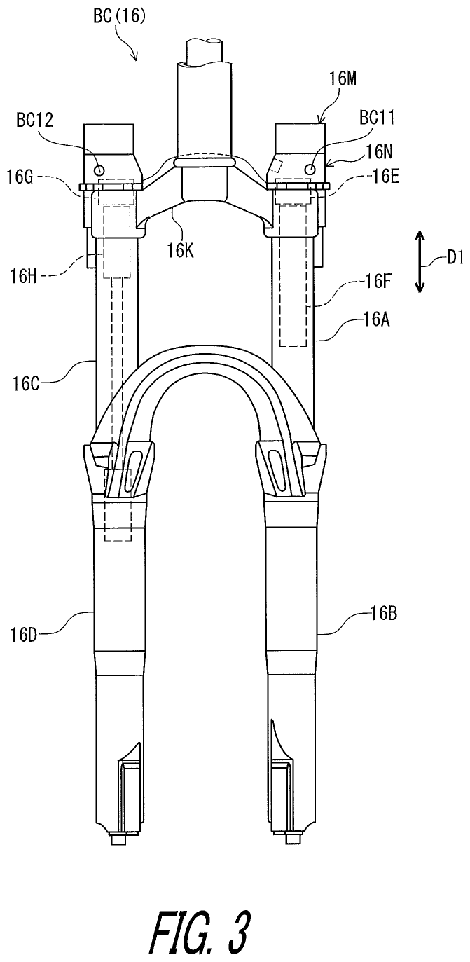

As seen in FIG. 3, the suspension 16 includes a first longitudinal member 16A and a second longitudinal member 16B. The first longitudinal member 16A and the second longitudinal member 16B are relatively movable. The suspension 16 includes a crown 16L. The first longitudinal member 16A is coupled to the crown 16L. The wheel FW is rotatably coupled to the second longitudinal member 16B. For example, the first longitudinal member 16A and the second longitudinal member 16B define a fluid chamber filled with a fluid such as oil.

The suspension 16 includes a third longitudinal member 16C and a fourth longitudinal member 16D. The third longitudinal member 16C and the fourth longitudinal member 16D are relatively movable. The third longitudinal member 16C is coupled to the crown 16L. The wheel FW is rotatably coupled to the fourth longitudinal member 16D. For example, the third longitudinal member 16C and the fourth longitudinal member 16D define an air chamber filled with air.

The suspension 16 comprises an electric actuator 16E and an actuator driver 16J. The electric actuator 16E is configured to generate an actuation force. Examples of the electric actuator 16E include an electric motor. The actuator driver 16J is electrically connected to the electric actuator 16E to control the electric actuator 16E.

The suspension 16 includes a state changing structure 16F configured to change the state of the suspension 16 between a first state and a second state. The electric actuator 16E is configured to actuate the state changing structure 16F to change the state of the suspension 16 between the first state and the second state. For example, the state changing structure 16F includes a valve unit. The electric actuator 16E is coupled to the state changing structure 16F. The electric actuator 16E is configured to actuate the state changing structure 16F to change the state of the suspension 16 between the first state and the second state.

For example, the state changing structure 16F is configured to allow the first longitudinal member 16A and the second longitudinal member 16B to relatively move under a first damping property in the first state. The state changing structure 16F is configured to allow the first longitudinal member 16A and the second longitudinal member 16B to relatively move under a second damping property in the second state. The second damping property is different from the first damping property.

The suspension 16 comprises an electric actuator 16G and an actuator driver 16K. The electric actuator 16G is configured to generate an actuation force. Examples of the electric actuator 16G include an electric motor. The actuator driver 16K is electrically connected to the electric actuator 16G to control the electric actuator 16G.

The suspension 16 includes a state changing structure 16H configured to change the state of the suspension 16 between a third state and a fourth state. The electric actuator 16E is configured to actuate the state changing structure 16H to change the state of the suspension 16 between the third state and the fourth state. For example, the state changing structure 16H includes a valve unit. The electric actuator 16G is coupled to the state changing structure 16H. The electric actuator 16G is configured to actuate the state changing structure 16H to change the state of the suspension 16 between the first state and the second state.

For example, the state changing structure 16H is configured to allow the third longitudinal member 16C and the fourth longitudinal member 16D to relatively move within a first stroke in the third state. The state changing structure 16H is configured to allow the third longitudinal member 16C and the fourth longitudinal member 16D to relatively move within a second stroke in the fourth state. The second stroke is different from the first stroke. One of the first stroke and the second stroke can be zero.

In the present embodiment, the suspension 16 includes the electric actuator 16E, the state changing structure 16F, the electric actuator 16G, and the state changing structure 16H. However, the electric actuator 16E and the state changing structure 16F can be omitted from the suspension 16 if needed or desired. The electric actuator 16G and the state changing structure 16H can be omitted from the suspension 16 if needed or desired. Furthermore, the suspension 16 can include another type of a state changing structure other than the state changing structures 16F and 16H if needed or desired.

As seen in FIG. 1, the suspension 18 is configured to absorb or damp shocks or vibrations generated by riding on rough terrain. The suspension 18 is coupled to the front frame body FB and the rear frame body RB. The suspension 18 is configured to absorb or damp shocks or vibrations transmitted from at least one of the wheels FW and RW.

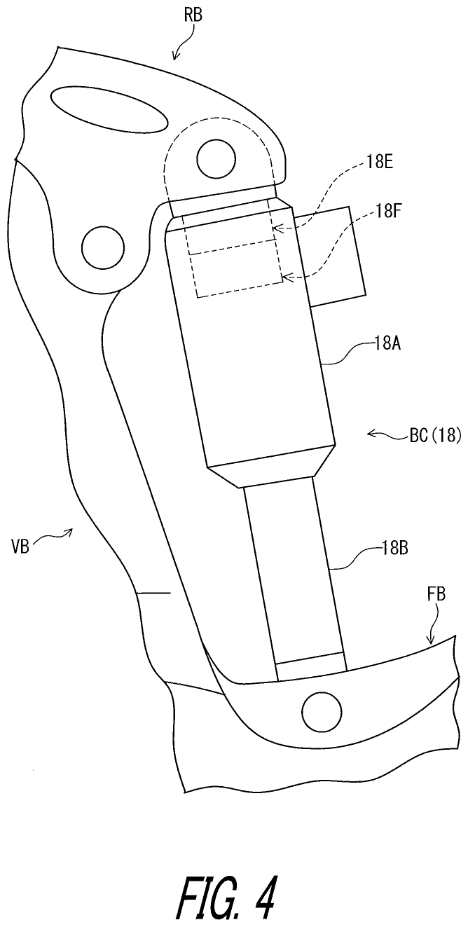

As seen in FIG. 4, the suspension 18 includes a first longitudinal member 18A and a second longitudinal member 18B. The first longitudinal member 18A and the second longitudinal member 18B are relatively movable. The first longitudinal member 18A and the second longitudinal member 18B define an air chamber or a fluid chamber. The first longitudinal member 18A is pivotally coupled to the rear frame body RB. The second longitudinal member 18B is pivotally coupled to the front frame body FB.

The suspension 18 comprises an electric actuator 18E. The electric actuator 18E is configured to generate an actuation force. Examples of the electric actuator 18E include an electric motor.

The suspension 18 includes a state changing structure 18F configured to change the state of the suspension 18 between a first state and a second state. The electric actuator 18E is configured to actuate the state changing structure 18F to change the state of the suspension 18 between the first state and the second state. For example, the state changing structure 18F includes a valve unit. The electric actuator 18E is coupled to the state changing structure 18F. The electric actuator 18E is configured to actuate the state changing structure 18F to change the state of the suspension 18 between the first state and the second state.

The state changing structure 18F is configured to allow the first longitudinal member 18A and the second longitudinal member 18B to relatively move within a first stroke or under a first damping property in the first state. The state changing structure 18F is configured to allow the first longitudinal member 18A and the second longitudinal member 18B to relatively move within a second stroke or under a second damping property in the second state.

As seen in FIG. 1, the adjustable seatpost 20 is configured to change a height of the saddle S relative to the vehicle body VB. The adjustable seatpost 20 has an adjustable state and a locked state. The adjustable seatpost 20 allows the user to change the height of the saddle S in the adjustable state. The adjustable seatpost 20 is locked to maintain the height of the saddle S in the locked state. The adjustable seatpost 20 is configured to change the state of the adjustable seatpost 20 between the adjustable state and the locked state.

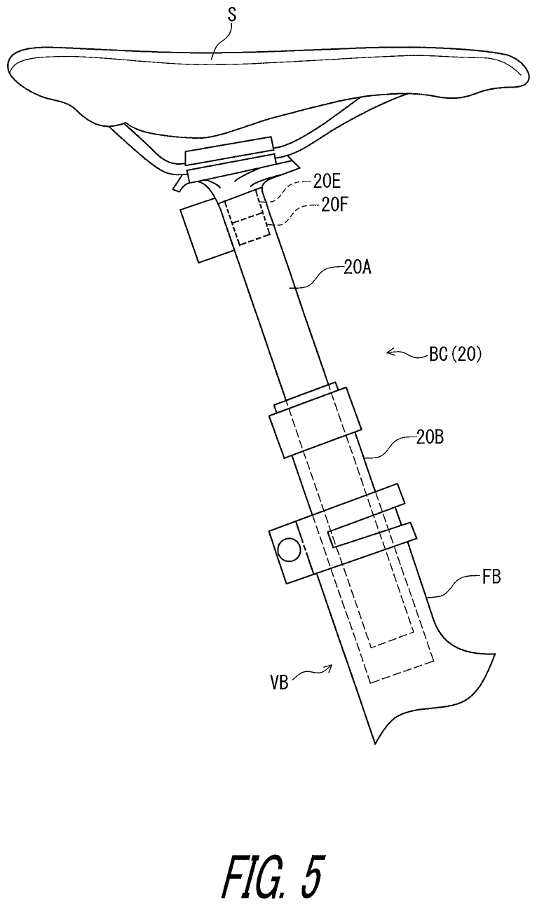

As seen in FIG. 5, the adjustable seatpost 20 includes a first longitudinal member 20A and a second longitudinal member 20B. The first longitudinal member 20A and the second longitudinal member 20B are relatively movable. The saddle S is coupled to the first longitudinal member 20A. The second longitudinal member 20B is coupled to the vehicle body VB.

The adjustable seatpost 20 comprises an electric actuator 20E. The electric actuator 20E is configured to generate an actuation force. Examples of the electric actuator 20E include an electric motor.

The adjustable seatpost 20 includes a state changing structure 20F configured to change the state of the adjustable seatpost 20 between the adjustable state and the locked state. The electric actuator 20E is configured to actuate the state changing structure 20F to change the state of the adjustable seatpost 20 between the adjustable state and the locked state. For example, the state changing structure 20F includes a valve unit. The electric actuator 20E is coupled to the state changing structure 20F. The electric actuator 20E is configured to actuate the state changing structure 20F to change the state of the adjustable seatpost 20 between the adjustable state and the locked state.

The state changing structure 20F is configured to allow the first longitudinal member 20A and the second longitudinal member 20B to relatively move in the adjustable state. The state changing structure 20F is configured to restrict the first longitudinal member 20A and the second longitudinal member 20B from relatively moving in the locked state.

As seen in FIG. 1, the assist drive unit 22 is configured to assist propulsion of the human-powered vehicle B. The assist drive unit 22 is configured to change an assist ratio depending on a human power applied to the human-powered vehicle B. For example, the assist drive unit 22 is configured to change the assist ratio depending on pedaling torque applied to the crank C.

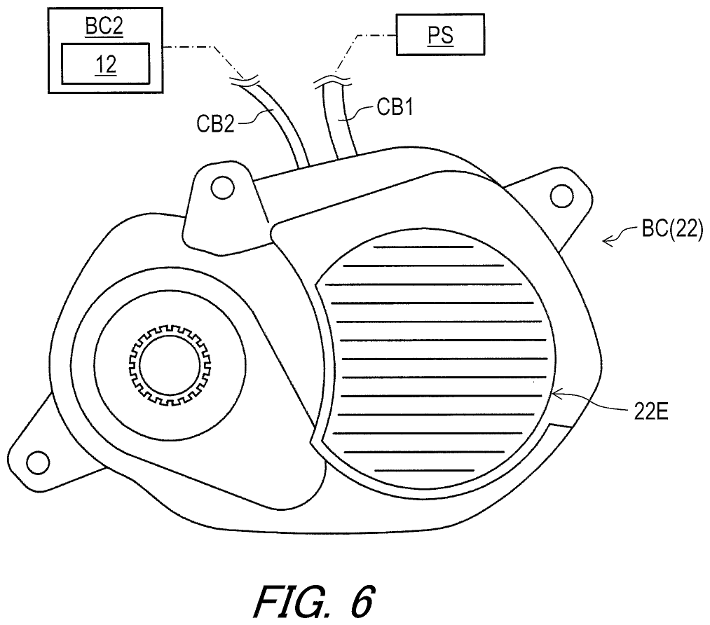

As seen in FIG. 6, the assist drive unit 22 comprises a housing 22A and an electric actuator 22E. The electric actuator 22E is at least partially provided in the housing 22A. The electric actuator 22E is configured to generate an actuation force. Examples of the electric actuator 22E include an electric motor. The electric actuator 22E is configured to apply the actuation force to the human-powered vehicle B to assist propulsion of the human-powered vehicle B.

As seen in FIG. 1, the at least two human-powered vehicle components BC includes a first operating device 24 and a second operating device 26. The first operating device 24 is configured to be mounted to the handlebar H (see e.g., FIG. 1) in a conventional manner. The first operating device 24 is configured to receive a first user operation. The first operating device 24 is configured to operate at least one of the at least two human-powered vehicle components BC in response to the first user operation. The second operating device 26 is configured to be mounted to the handlebar H (see e.g., FIG. 1) in a conventional manner. The second operating device 26 is configured to receive a second user operation. The second operating device 26 is configured to operate at least one of the at least two human-powered vehicle components BC in response to the second user operation.

The first operating device 24 is configured to operate at least one of the gear changer 12, the suspension 16, the suspension 18, the adjustable seatpost 20, and the assist drive unit 22 in response to the first user operation. The second operating device 26 is configured to operate at least one of the gear changer 12, the suspension 16, the suspension 18, the adjustable seatpost 20, and the assist drive unit 22 in response to the second user operation. The at least two human-powered vehicle components BC can include another operating device other than the first operating device 24 and the second operating device 26 if needed or desired.

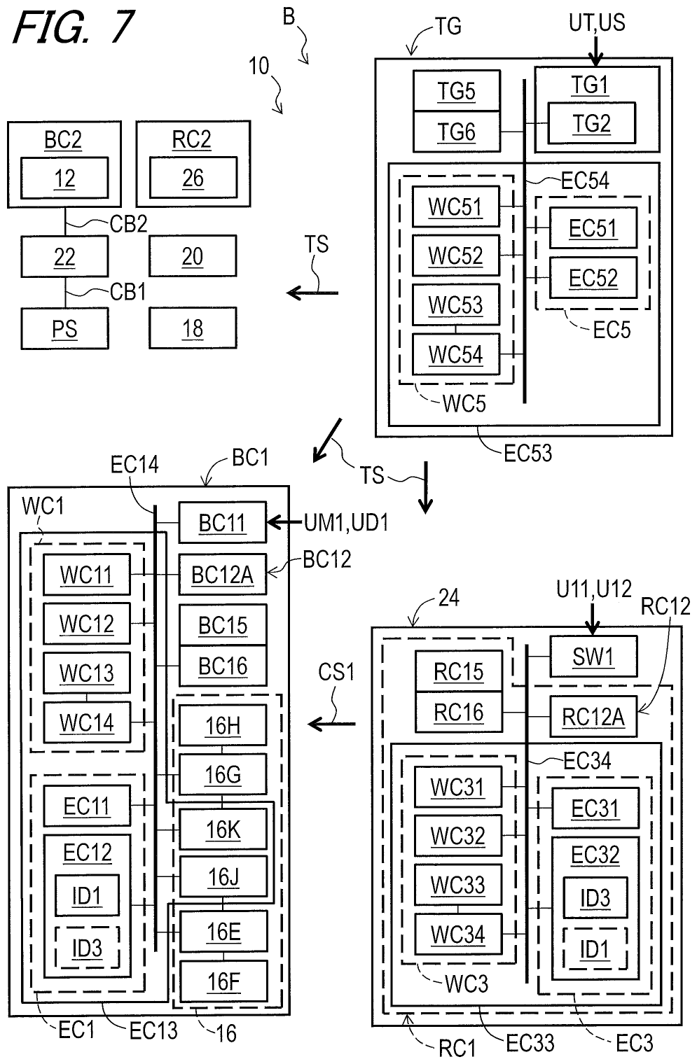

As seen in FIG. 7, the human-powered vehicle control system 10 comprises a first remote component RC1. The first remote component RC1 is configured to wirelessly transmit wireless signals that include each pairing information that identifies the source of the wireless signal as coming from the first remote component RC1. The human-powered vehicle B includes a first input device SW1. The first input device SW1 is configured to receive a first user input U11. The first remote component RC1 is configured to control a mode of the first remote component RC1 in response to the first user input U11.

The first input device SW1 is configured to receive a first user control input U12. The first remote component RC1 is configured to generate a first signal CS1 in response to the first user control input U12. The first remote component RC1 is configured to transmit the first signal CS1 in response to the first user control input U12. The first signal CS1 can be used to control another component.

The first input device SW1 is configured to generate an electrical signal when operated or configured to cause the first remote component RC1 to generate the first signal CS1. For example, the first input device SW1 includes at least one switch configured to close or open a circuit to generate an electrical signal. However, the first input device SW1 can include a structure other than the switch if needed or desired.

Examples of the first user input U11 include a normal press or a long press of a switch. Examples of the first user control input U12 include at least one of a normal press and a long press of the switch or another switch.

In the present embodiment, the first operating device 24 includes the first input device SW1 and the first remote component RC1. Namely, one of the at least two human-powered vehicle components BC includes the first input device SW1 and the first remote component RC1. The first user operation includes at least one of the first user input U11 and the first user control input U12. Thus, the first operating device 24 is configured to transmit the first signal CS1 in response to the first user control input U12. However, at least one of the first input device SW1 and the first remote component RC1 can be provided to another device other than the first operating device 24 if needed or desired.

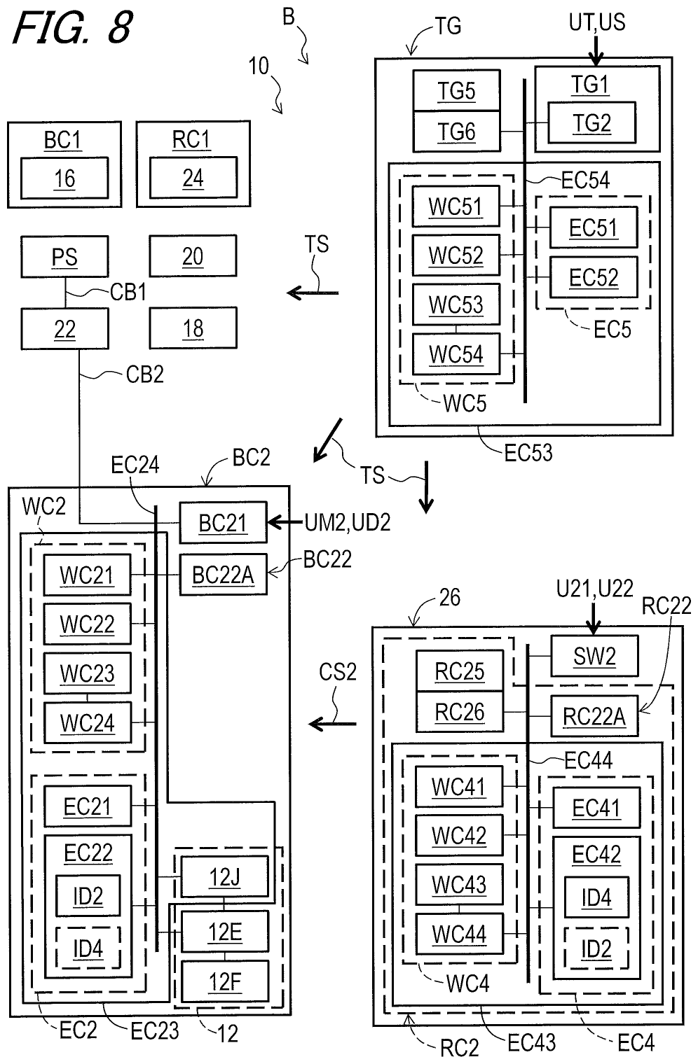

As seen in FIG. 8, the human-powered vehicle B includes a second remote component RC2. The second remote component RC2 is configured to wirelessly transmit wireless signals that include each pairing information that identifies the source of the wireless signal as coming from the second remote component RC2. The human-powered vehicle B includes a second input device SW2. The second input device SW2 is configured to receive a second user input U21. The second remote component RC2 is configured to control a mode of the second remote component RC2 in response to the second user input U21.

The second input device SW2 is configured to receive a second user control input U22. The second remote component RC2 is configured to generate a second signal CS2 in response to the second user control input U22. The second remote component RC2 is configured to transmit the second signal CS2 in response to the second user control input U22.

The second input device SW2 is configured to generate an electrical signal when operated or configured to cause the second remote component to generate the second signal CS2. For example, the second input device SW2 includes at least one switch configured to close or open a circuit to generate an electrical signal. However, the second input device SW2 can include a structure other than the switch if needed or desired.

Examples of the second user input U21 include a normal press or a long press of a switch. Examples of the second user control input U22 include at least one of a normal press and a long press of the switch or another switch.

In the present embodiment, the second operating device 26 includes the second input device SW2 and the second remote component RC2. Namely, one of the at least two human-powered vehicle components BC includes the second input device SW2 and the second remote component RC2. The second user operation includes at least one of the second user input U21 and the second user control input U22. Thus, the second operating device 26 is configured to transmit the second signal in response to the second user input U21. However, at least one of the second input device SW2 and the second remote component RC2 can be provided to another device other than the second operating device 26 if needed or desired.

As seen in FIG. 1, the human-powered vehicle B further includes an electrical power source PS. Here, the electrical power source PS includes a battery pack that includes one or more batteries. As illustrated in FIG. 1, the electrical power source PS is provided in the downtube of the vehicle body VB. Alternatively, the electrical power source PS can be attached an outer surface of the vehicle body VB. For example, the electrical power source PS includes one or more rechargeable batteries.

The electrical power source PS is electrically connected to at least one of the gear changer 12, the suspension 16, the suspension 18, the adjustable seatpost 20, the assist drive unit 22, the first operating device 24, and the second operating device 26. The electrical power source PS is configured to supply electrical power to the at least one of the gear changer 12, the suspension 16, the suspension 18, the adjustable seatpost 20, the assist drive unit 22, the first operating device 24, and the second operating device 26. In the present embodiment, the electrical power source PS is electrically connected to the gear changer 12 and the assist drive unit 22 to supply electrical power to the gear changer 12 and the assist drive unit 22. However, the electrical power source PS can be configured to be electrically connected to a device other than the gear changer 12 and the assist drive unit 22 if needed or desired.

As seen in FIGS. 7 and 8, the at least two human-powered vehicle components BC includes a human-powered vehicle component BC1 and an additional human-powered vehicle component BC2. Namely, the human-powered vehicle control system 10 comprises the human-powered vehicle component BC1. The human-powered vehicle control system 10 further comprises the additional human-powered vehicle component BC2. The additional human-powered vehicle component BC2 can be omitted from the human-powered vehicle control system 10 if needed or desired. The human-powered vehicle component BC1 can also be referred to as a first human-powered vehicle component BC1. The additional human-powered vehicle component BC2 can also be referred to as a second human-powered vehicle component BC2.

The human-powered vehicle component BC1 includes one of the gear changer 12, the suspension 16, the suspension 18, the adjustable seatpost 20, the assist drive unit 22, the first operating device 24, and the second operating device 26. The additional human-powered vehicle component BC2 includes another of the gear changer 12, the suspension 16, the suspension 18, the adjustable seatpost 20, the assist drive unit 22, the first operating device 24, and the second operating device 26.

In the present embodiment, the human-powered vehicle component BC1 includes the suspension 16. The additional human-powered vehicle component BC2 includes the gear changer 12. However, the human-powered vehicle component BC1 is not limited to the suspension 16. The additional human-powered vehicle component BC2 is not limited to the gear changer 12. The human-powered vehicle component BC1 can include a device other than the suspension 16 if needed or desired. The additional human-powered vehicle component BC2 can include a device other than the gear changer 12 if needed or desired.

The first remote component RC1 is configured to be wirelessly communicate with another human-powered vehicle component such as the human-powered vehicle component BC1 and the additional human-powered vehicle component BC2. The second remote component RC2 is configured to be wirelessly communicate with another human-powered vehicle component such as the human-powered vehicle component BC1 and the additional human-powered vehicle component BC2.

As seen in FIG. 7, in the present embodiment, the human-powered vehicle component BC1 includes an electrical power source BC15 and a power source holder BC16. The electrical power source BC15 is configured to supply electrical power to the first electronic controller circuitry EC1, the first wireless communicator circuitry WC1, and other electronic parts of the human-powered vehicle component BC1. The electrical power source BC15 is configured to supply electrical power to the electric actuator 16E, the actuator driver 16J, the electric actuator 16G, the actuator driver 16K, and other electronic parts of the suspension 16. The power source holder BC16 is configured to detachably and reattachably hold the electrical power source BC15. The electrical power source BC15 is configured to be detachably and reattachably attached to the power source holder BC16. The power source holder BC16 is configured to be electrically connected to the first electronic controller circuitry EC1, the first wireless communicator circuitry WC1, and other electronic parts of the human-powered vehicle component BC1. The power source holder BC16 is configured to be electrically connected to the electric actuator 16E, the actuator driver 16J, the electric actuator 16G, the actuator driver 16K, and other electronic parts of the suspension 16. The electrical power source BC15 is configured to supply electrical power to the first electronic controller circuitry EC1, the first wireless communicator circuitry WC1, and other electronic parts of the human-powered vehicle component BC1 via the power source holder BC16. The electrical power source BC15 is configured to supply electrical power to the electric actuator 16E, the actuator driver 16J, the electric actuator 16G, the actuator driver 16K, and other electronic parts of the suspension 16 via the power source holder BC16. Examples of the electrical power source BC15 includes a primary battery and a secondary battery.

As with the human-powered vehicle component BC1, each of the suspension 18, the adjustable seatpost 20, the first operating device 24, and the second operating device 26 include its own electrical power source. However, at least one of the suspension 16, the suspension 18, the adjustable seatpost 20, the first operating device 24, and the second operating device 26 can be electrically connected to the electrical power source PS if needed or desired.

As seen in FIG. 8, in the present embodiment, the additional human-powered vehicle component BC2 is configured to be electrically connected to the electrical power source PS. In the present embodiment, the assist drive unit 22 is electrically connected to the electrical power source PS by a first electrical cable CB1. The gear changer 12 is electrically connected to an electrical junction of the assist drive unit 22 by a second electrical cable CB2. In a case where the additional human-powered vehicle component BC2 includes the gear changer 12, the additional human-powered vehicle component BC2 is electrically connected to the electrical junction of the assist drive unit 22 by the second electrical cable CB2. In other words, here, the additional human-powered vehicle component BC2 and the gear changer 12 receive electrical power from the electrical power source PS via the assist drive unit 22. Alternatively, the additional human-powered vehicle component BC2 and the gear changer 12 can be directly connected to the electrical power source PS to receive the electrical power directly from the electrical power source PS. When the assist drive unit 22 is in the off mode, the electrical power from the electrical power source PS is disconnected from the additional human-powered vehicle component BC2 and the gear changer 12. Thus, when the assist drive unit 22 is turned on, the electrical power from the electrical power source PS is supplied to the additional human-powered vehicle component BC2 and the gear changer 12. Preferably, the first electrical cable CB1 and the second electrical cable CB2 have pluggable electrical connectors provided at one or both ends for easy connection and disconnection. Also, alternatively, at least one of the first electrical cable CB1 and the second electrical cable CB2 can be power line communication (PLC) cables if needed or desired.

As seen in FIG. 7, the human-powered vehicle B includes a trigger input device TG. The trigger input device TG is configured to receive a user trigger input UT. The trigger input device TG is configured to generate a pairing trigger signal TS in response to the user trigger input UT. The trigger input device TG is configured to transmit the pairing trigger signal TS in response to the user trigger input UT to another component such as the human-powered vehicle component BC1 and the additional human-powered vehicle component BC2.

In the present embodiment, the trigger input device TG includes a display TG1. The display TG1 is configured to display information relating to at least one of the trigger input device TG and the human-powered vehicle B. The trigger input device TG includes at least one of a smartphone, a tablet computer, a personal computer, and a wearable device. The trigger input device TG includes at least one of the smartphone, the tablet computer, the personal computer, the wearable device, and a cycle computer.

The trigger input device TG has a function other than a function relating to the human-powered vehicle B. For example, the trigger input device TG has a function such as a telephone function, a message transmitting function, a message receiving function, and a web browsing function. The trigger input device TG can have a function relating to the human-powered vehicle, such as an adjustment function for a gear changer, and a Global Positioning System (GPS) function. The trigger input device TG has a cycle computer function and a vehicle operating function in addition to or instead of the above-mentioned functions. The cycle computer function includes a speed displaying function and a cadence displaying function. The vehicle operating function includes a state change function of at least one device of the human-powered vehicle. However, the trigger input device TG can be free of a function other than the function relating to the human-powered vehicle if needed or desired.

In the present embodiment, the display TG1 includes a touch panel TG2 configured to receive the user trigger input UT. However, the touch panel TG2 can be omitted from the trigger input device TG if needed or desired.

The first wireless communicator circuitry WC1 is configured to wirelessly receive the pairing trigger signal TS generated in response to the user trigger input UT received by the at least one of the smartphone, the tablet computer, the personal computer, the wearable device, and the cycle computer. Examples of the wearable device include a watch, a bracelet, a ring, a necklace, a belt, a helmet, a belt, and a device attachable to these items.

In the present embodiment, the trigger input device TG is provided separately from at least one of the first remote component RC1 and the first input device SW1. The trigger input device TG is provided separately from at least one of the first remote component RC1, the first input device SW1, the second remote component RC2, and the second input device SW2. The trigger input device TG is provided separately from at least one of the first remote component RC1, the first input device SW1, the second remote component RC2, the second input device SW2, the human-powered vehicle component BC1, and the additional human-powered vehicle component BC2. However, the trigger input device TG can include at least one of the first remote component RC1 and the first input device SW1 if needed or desired. The trigger input device TG can include the first remote component RC1, the first input device SW1, or both the first remote component RC1 and the first input device SW1 if needed or desired. Furthermore, the additional human-powered vehicle component BC2 can include the trigger input device TG if needed or desired.

As seen in FIG. 7, the human-powered vehicle component BC1 is configured to wirelessly communicate with another component such as the additional human-powered vehicle component BC2, the first remote component RC1, and the second remote component RC2. The human-powered vehicle component BC1 comprises first wireless communicator circuitry WC1 and first electronic controller circuitry EC1. The first wireless communicator circuitry WC1 is configured to wirelessly communicate with another wireless communicator circuitry. The first electronic controller circuitry EC1 is configured to control the first wireless communicator circuitry WC1 to wirelessly communicate with another wireless communicator circuitry.

The human-powered vehicle component BC1 includes a circuit board EC13 and a system bus EC14. The first wireless communicator circuitry WC1 and the first electronic controller circuitry EC1 are electrically mounted on the circuit board EC13. The first electronic controller circuitry EC1 includes a processor EC11 and a memory EC12. The processor EC11 is coupled to the memory EC12. The memory EC12 is coupled to the processor EC11. The processor EC11 and the memory EC12 are electrically mounted on the circuit board EC13. The processor EC11 is electrically connected to the memory EC12 via the circuit board EC13 and the system bus EC14. The memory EC12 is electrically connected to the processor EC11 via the circuit board EC13 and the system bus EC14. For example, the first electronic controller circuitry EC1 includes a semiconductor. The processor EC11 includes a semiconductor. The memory EC12 includes a semiconductor. However, the first electronic controller circuitry EC1 can be free of a semiconductor if needed or desired. The processor EC11 can be free of a semiconductor if needed or desired. The memory EC12 can be free of a semiconductor if needed or desired.

For example, the processor EC11 includes at least one of a central processing unit (CPU), a micro processing unit (MPU), and a memory controller. The memory EC12 is electrically connected to the processor EC11. For example, the memory EC12 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC12 includes storage areas each having an address. The processor EC11 is configured to control the memory EC12 to store data in the storage areas of the memory EC12 and reads data from the storage areas of the memory EC12. The processor EC11 can also be referred to as a hardware processor EC11 or a processor circuit or circuitry EC11. The memory EC12 can also be referred to as a hardware memory EC12 or a memory circuit or circuitry EC12. The memory EC12 can also be referred to as a non-transitory computer-readable storage medium EC12. Namely, the first electronic controller circuitry EC1 includes the non-transitory computer-readable storage medium EC12.

The first electronic controller circuitry EC1 is configured to execute at least one control algorithm of the human-powered vehicle component BC1. For example, the first electronic controller circuitry EC1 is programed to execute at least one control algorithm of the human-powered vehicle component BC1. The memory EC12 stores at least one program including at least one program instruction. The at least one program is read into the processor EC11, and thereby the at least one control algorithm of the human-powered vehicle component BC1 is executed based on the at least one program.

The structure of the first electronic controller circuitry EC1 is not limited to the above structure. The structure of the first electronic controller circuitry EC1 is not limited to the processor EC11 and the memory EC12. The first electronic controller circuitry EC1 can be realized by hardware alone or a combination of hardware and software. In the present embodiment, the processor EC11 and the memory EC12 are integrated as a single chip such as an application specific integrated circuit (ASIC) or a field programmable gate array (FPGA). However, the processor EC11 and the memory EC12 can be separate chips if needed or desired. The first electronic controller circuitry EC1 can include the processor EC11, the memory EC12, the circuit board EC13, and the system bus EC14 if needed or desired.

The first electronic controller circuitry EC1 can include at least two electronic controller circuits which are separately provided. The at least one control algorithm of the human-powered vehicle component BC1 can be executed by the at least two electronic controller circuits if needed or desired. The first electronic controller circuitry EC1 can include at least two processors which are separately provided. The first electronic controller circuitry EC1 can include at least two memories which are separately provided. The at least one control algorithm of the human-powered vehicle component BC1 can be executed by the at least two processors if needed or desired. The at least one control algorithm of the human-powered vehicle component BC1 can be stored in the at least two memories if needed or desired. The first electronic controller circuitry EC1 can include at least two circuit boards which are separately provided if needed or desired. The first electronic controller circuitry EC1 can include at least two system buses which are separately provided if needed or desired.

The first wireless communicator circuitry WC1 is electrically mounted on the circuit board EC13. The first wireless communicator circuitry WC1 is electrically connected to the processor EC11 and the memory EC12 with the circuit board EC13 and the system bus EC14. For example, the first wireless communicator circuitry WC1 includes first signal transmitting circuitry WC11, first signal receiving circuitry WC12, and first antenna circuitry WC13. The first signal transmitting circuitry WC11 is electrically connected to the first antenna circuitry WC13. The first signal receiving circuitry WC12 is electrically connected to the first antenna circuitry WC13.

The first wireless communicator circuitry WC1 is configured to transmit wireless signals via the first antenna circuitry WC13. The first wireless communicator circuitry WC1 is configured to superimpose digital signals on carrier wave using a predetermined wireless communication protocol to wirelessly transmit signals. In the present embodiment, the first wireless communicator circuitry WC1 is configured to encrypt signals using a cryptographic key to generate encrypted wireless signals.

The first wireless communicator circuitry WC1 is configured to receive wireless signals via the first antenna circuitry WC13. In the present embodiment, the first wireless communicator circuitry WC1 is configured to decode the wireless signals to recognize signals transmitted from other wireless communicators. The first wireless communicator circuitry WC1 is configured to decrypt the wireless signals using the cryptographic key.

The first wireless communicator circuitry WC1 includes a first signal amplifier WC14. The first signal amplifier WC14 is coupled to the first signal transmitting circuitry WC11, the first signal receiving circuitry WC12, and the first antenna circuitry WC13. The first signal amplifier WC14 is configured to selectively amplify the signals of the first antenna circuitry WC13. The first signal amplifier WC14 can be controlled by the first electronic controller circuitry EC1. The first electronic controller circuitry EC1 is configured to control the first signal amplifier WC14 such that the first signal amplifier WC14 operates in a first low power consumption state in a state where the human-powered vehicle component BC1 is in the wireless signal listening mode. The first electronic controller circuitry EC1 is configured to control the first signal amplifier WC14 such that the first signal amplifier WC14 operates in a first high power consumption state in a state where the human-powered vehicle component BC1 is in the first pairing mode. The first low power consumption state has a lower power consumption than the first high power consumption state. For example, the first signal amplifier WC14 operates intermittently, sleeps or turns off in the first low power consumption state where the human-powered vehicle component BC1 is in the wireless signal listening mode. In this way, the first wireless communicator circuitry WC1 is less likely incorrectly paired by reducing the signal strength where the human-powered vehicle component BC1 is in the first pairing mode. On the other hand, in all other modes, the first signal amplifier WC14 is operated at full strength to ensure receiving a control signal.

The human-powered vehicle component BC1 further comprises a user interface BC11 configured to receive a user operation. The first electronic controller circuitry EC1 is electrically connected to the user interface BC11 to detect the user operation received by the user interface BC11. Examples of the user interface BC11 include a switch. The user operation indicates at least one of an on-operation, an off-operation, transmission of a signal, and a change in a state of the human-powered vehicle component BC1. The user interface BC11 can be omitted from the human-powered vehicle component BC1 if needed or desired.

As seen in FIG. 8, the additional human-powered vehicle component BC2 is configured to be wirelessly communicate with another component such as the human-powered vehicle component BC1, the first remote component RC1, and the second remote component RC2. The additional human-powered vehicle component BC2 comprises second wireless communicator circuitry WC2 and second electronic controller circuitry EC2. The second wireless communicator circuitry WC2 is configured to wirelessly communicate with another wireless communicator circuitry. The second electronic controller circuitry EC2 is configured to control the second wireless communicator circuitry WC2 to wirelessly communicate with another wireless communicator circuitry.

The additional human-powered vehicle component BC2 includes a circuit board EC23 and a system bus EC24. The second wireless communicator circuitry WC2 and the second electronic controller circuitry EC2 are electrically mounted on the circuit board EC23. The second electronic controller circuitry EC2 includes a processor EC21 and a memory EC22. The processor EC21 is coupled to the memory EC22. The memory EC22 is coupled to the processor EC21. The processor EC21 and the memory EC22 are electrically mounted on the circuit board EC23. The processor EC21 is electrically connected to the memory EC22 via the circuit board EC23 and the system bus EC24. The memory EC22 is electrically connected to the processor EC21 via the circuit board EC23 and the system bus EC24. For example, the second electronic controller circuitry EC2 includes a semiconductor. The processor EC21 includes a semiconductor. The memory EC22 includes a semiconductor. However, the second electronic controller circuitry EC2 can be free of a semiconductor if needed or desired. The processor EC21 can be free of a semiconductor if needed or desired. The memory EC22 can be free of a semiconductor if needed or desired.

For example, the processor EC21 includes at least one of a central processing unit (CPU), a micro processing unit (MPU), and a memory controller. The memory EC22 is electrically connected to the processor EC21. For example, the memory EC22 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC22 includes storage areas each having an address. The processor EC21 is configured to control the memory EC22 to store data in the storage areas of the memory EC22 and reads data from the storage areas of the memory EC22. The processor EC21 can also be referred to as a hardware processor EC21 or a processor circuit or circuitry EC21. The memory EC22 can also be referred to as a hardware memory EC22 or a memory circuit or circuitry EC22. The memory EC22 can also be referred to as a non-transitory computer-readable storage medium EC22. Namely, the second electronic controller circuitry EC2 includes the non-transitory computer-readable storage medium EC22.

The second electronic controller circuitry EC2 is configured to execute at least one control algorithm of the additional human-powered vehicle component BC2. For example, the second electronic controller circuitry EC2 is programed to execute at least one control algorithm of the additional human-powered vehicle component BC2. The memory EC22 stores at least one program including at least one program instruction. The at least one program is read into the processor EC21, and thereby the at least one control algorithm of the additional human-powered vehicle component BC2 is executed based on the at least one program.

The structure of the second electronic controller circuitry EC2 is not limited to the above structure. The structure of the second electronic controller circuitry EC2 is not limited to the processor EC21 and the memory EC22. The second electronic controller circuitry EC2 can be realized by hardware alone or a combination of hardware and software. In the present embodiment, the processor EC21 and the memory EC22 are integrated as a single chip such as an application specific integrated circuit (ASIC) or a field programmable gate array (FPGA). However, the processor EC21 and the memory EC22 can be separate chips if needed or desired. The second electronic controller circuitry EC2 can include the processor EC21, the memory EC22, the circuit board EC23, and the system bus EC24 if needed or desired.

The second electronic controller circuitry EC2 can include at least two electronic controller circuits which are separately provided. The at least one control algorithm of the additional human-powered vehicle component BC2 can be executed by the at least two electronic controller circuits if needed or desired. The second electronic controller circuitry EC2 can include at least two processors which are separately provided. The second electronic controller circuitry EC2 can include at least two memories which are separately provided. The at least one control algorithm of the additional human-powered vehicle component BC2 can be executed by the at least two processors if needed or desired. The at least one control algorithm of the additional human-powered vehicle component BC2 can be stored in the at least two memories if needed or desired. The second electronic controller circuitry EC2 can include at least two circuit boards which are separately provided if needed or desired. The second electronic controller circuitry EC2 can include at least two system buses which are separately provided if needed or desired.

The second wireless communicator circuitry WC2 is electrically mounted on the circuit board EC23. The second wireless communicator circuitry WC2 is electrically connected to the processor EC21 and the memory EC22 with the circuit board EC23 and the system bus EC24. For example, the second wireless communicator circuitry WC2 includes second signal transmitting circuitry WC21, second signal receiving circuitry WC22, and second antenna circuitry WC23. The second signal transmitting circuitry WC21 is electrically connected to the second antenna circuitry WC23. The second signal receiving circuitry WC22 is electrically connected to the second antenna circuitry WC23.

The second wireless communicator circuitry WC2 is configured to transmit wireless signals via the second antenna circuitry WC23. The second wireless communicator circuitry WC2 is configured to superimpose digital signals on carrier wave using a predetermined wireless communication protocol to wirelessly transmit signals. In the present embodiment, the second wireless communicator circuitry WC2 is configured to encrypt signals using a cryptographic key to generate encrypted wireless signals.

The second wireless communicator circuitry WC2 is configured to receive wireless signals via the second antenna circuitry WC23. In the present embodiment, the second wireless communicator circuitry WC2 is configured to decode the wireless signals to recognize signals transmitted from other wireless communicators. The second wireless communicator circuitry WC2 is configured to decrypt the wireless signals using the cryptographic key.

The second wireless communicator circuitry WC2 includes a second signal amplifier WC24. The second signal amplifier WC24 is coupled to the second signal transmitting circuitry WC21, the second signal receiving circuitry WC22, and the second antenna circuitry WC23. The second signal amplifier WC24 is configured to selectively amplify the signals of the second antenna circuitry WC23. The second signal amplifier WC24 can be controlled by the second electronic controller circuitry EC2. The second electronic controller circuitry EC2 is configured to control the second signal amplifier WC24 such that the second signal amplifier WC24 operates in a second low power consumption state in a state where the additional human-powered vehicle component BC2 is in the wireless signal listening mode. The second electronic controller circuitry EC2 is configured to control the second signal amplifier WC24 such that the second signal amplifier WC24 operates in a second high power consumption state in a state where the additional human-powered vehicle component BC2 is in the second pairing mode. The second low power consumption state has a lower power consumption than the second high power consumption state. For example, the second signal amplifier WC24 operates intermittently, sleeps or turns off in the second low power consumption state where the additional human-powered vehicle component BC2 is in the wireless signal listening mode. In this way, the second wireless communicator circuitry WC2 is less likely incorrectly paired by reducing the signal strength where the additional human-powered vehicle component BC2 is in the second pairing mode. On the other hand, in all other modes, the second signal amplifier WC24 is operated at full strength to ensure receiving a control signal.

The additional human-powered vehicle component BC2 further comprises a user interface BC21 configured to receive a user operation. The first electronic controller circuitry EC1 is electrically connected to the user interface BC11 to detect the user operation received by the user interface BC21. Examples of the user interface BC21 include a switch. The user operation indicates at least one of an on-operation, an off-operation, transmission of a signal, and a change in a state of the additional human-powered vehicle component BC2. The user interface BC21 can be omitted from the additional human-powered vehicle component BC2 if needed or desired.

As seen in FIG. 7, the first remote component RC1 is configured to be wirelessly communicate with another component such as the human-powered vehicle component BC1, the additional human-powered vehicle component BC2, and the second remote component RC2. The first remote component RC1 comprises third wireless communicator circuitry WC3 and third electronic controller circuitry EC3. The third wireless communicator circuitry WC3 is configured to wirelessly communicate with another wireless communicator circuitry. The third electronic controller circuitry EC3 is configured to control the third wireless communicator circuitry WC3 to wirelessly communicate with another wireless communicator circuitry.

The first remote component RC1 includes a circuit board EC33 and a system bus EC34. The third wireless communicator circuitry WC3 and the third electronic controller circuitry EC3 are electrically mounted on the circuit board EC33. The third electronic controller circuitry EC3 includes a processor EC31 and a memory EC32. The processor EC31 is coupled to the memory EC32. The memory EC32 is coupled to the processor EC31. The processor EC31 and the memory EC32 are electrically mounted on the circuit board EC33. The processor EC31 is electrically connected to the memory EC32 via the circuit board EC33 and the system bus EC34. The memory EC32 is electrically connected to the processor EC31 via the circuit board EC33 and the system bus EC34. For example, the third electronic controller circuitry EC3 includes a semiconductor. The processor EC31 includes a semiconductor. The memory EC32 includes a semiconductor. However, the third electronic controller circuitry EC3 can be free of a semiconductor if needed or desired. The processor EC31 can be free of a semiconductor if needed or desired. The memory EC32 can be free of a semiconductor if needed or desired.

For example, the processor EC31 includes at least one of a central processing unit (CPU), a micro processing unit (MPU), and a memory controller. The memory EC32 is electrically connected to the processor EC31. For example, the memory EC32 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC32 includes storage areas each having an address. The processor EC31 is configured to control the memory EC32 to store data in the storage areas of the memory EC32 and reads data from the storage areas of the memory EC32. The processor EC31 can also be referred to as a hardware processor EC31 or a processor circuit or circuitry EC31. The memory EC32 can also be referred to as a hardware memory EC32 or a memory circuit or circuitry EC32. The memory EC32 can also be referred to as a non-transitory computer-readable storage medium EC32. Namely, the third electronic controller circuitry EC3 includes the non-transitory computer-readable storage medium EC32.

The third electronic controller circuitry EC3 is configured to execute at least one control algorithm of the first remote component RC1. For example, the third electronic controller circuitry EC3 is programed to execute at least one control algorithm of the first remote component RC1. The memory EC32 stores at least one program including at least one program instruction. The at least one program is read into the processor EC31, and thereby the at least one control algorithm of the first remote component RC1 is executed based on the at least one program.

The structure of the third electronic controller circuitry EC3 is not limited to the above structure. The structure of the third electronic controller circuitry EC3 is not limited to the processor EC31 and the memory EC32. The third electronic controller circuitry EC3 can be realized by hardware alone or a combination of hardware and software. In the present embodiment, the processor EC31 and the memory EC32 are integrated as a single chip such as an application specific integrated circuit (ASIC) or a field programmable gate array (FPGA). However, the processor EC31 and the memory EC32 can be separate chips if needed or desired. The third electronic controller circuitry EC3 can include the processor EC31, the memory EC32, the circuit board EC33, and the system bus EC34 if needed or desired.

The third electronic controller circuitry EC3 can include at least two electronic controller circuits which are separately provided. The at least one control algorithm of the first remote component RC1 can be executed by the at least two electronic controller circuits if needed or desired. The third electronic controller circuitry EC3 can include at least two processors which are separately provided. The third electronic controller circuitry EC3 can include at least two memories which are separately provided. The at least one control algorithm of the first remote component RC1 can be executed by the at least two processors if needed or desired. The at least one control algorithm of the first remote component RC1 can be stored in the at least two memories if needed or desired. The third electronic controller circuitry EC3 can include at least two circuit boards which are separately provided if needed or desired. The third electronic controller circuitry EC3 can include at least two system buses which are separately provided if needed or desired.

The third wireless communicator circuitry WC3 is electrically mounted on the circuit board EC33. The third wireless communicator circuitry WC3 is electrically connected to the processor EC31 and the memory EC32 with the circuit board EC33 and the system bus EC34. For example, the third wireless communicator circuitry WC3 includes third signal transmitting circuitry WC31, third signal receiving circuitry WC32, and third antenna circuitry WC33. The third signal transmitting circuitry WC31 is electrically connected to the third antenna circuitry WC33. The third signal receiving circuitry WC32 is electrically connected to the third antenna circuitry WC33.

The third wireless communicator circuitry WC3 is configured to transmit wireless signals via the third antenna circuitry WC33. The third wireless communicator circuitry WC3 is configured to superimpose digital signals on carrier wave using a predetermined wireless communication protocol to wirelessly transmit signals. In the present embodiment, the third wireless communicator circuitry WC3 is configured to encrypt signals using a cryptographic key to generate encrypted wireless signals.

The third wireless communicator circuitry WC3 is configured to receive wireless signals via the third antenna circuitry WC33. In the present embodiment, the third wireless communicator circuitry WC3 is configured to decode the wireless signals to recognize signals transmitted from other wireless communicators. The third wireless communicator circuitry WC3 is configured to decrypt the wireless signals using the cryptographic key.

The third wireless communicator circuitry WC3 includes a third signal amplifier WC34. The third signal amplifier WC34 is coupled to the third signal transmitting circuitry WC31, the third signal receiving circuitry WC32, and the third antenna circuitry WC33. The third signal amplifier WC34 is configured to selectively amplify the signals of the third antenna circuitry WC33. The third signal amplifier WC34 can be controlled by the third electronic controller circuitry EC3. The third electronic controller circuitry EC3 is configured to control the third signal amplifier WC34 such that the third signal amplifier WC34 operates in a third low power consumption state in a state where the first remote component RC1 is in the wireless signal listening mode. The third electronic controller circuitry EC3 is configured to control the third signal amplifier WC34 such that the third signal amplifier WC34 operates in a third high power consumption state in a state where the first remote component RC1 is in the third pairing mode. The third low power consumption state has a lower power consumption than the third high power consumption state. For example, the third signal amplifier WC34 operates intermittently, sleeps or turns off in the third low power consumption state where the first remote component RC1 is in the wireless signal listening mode. In this way, the third wireless communicator circuitry WC3 is less likely incorrectly paired by reducing the signal strength where the first remote component RC1 is in the third pairing mode. On the other hand, in all other modes, the third signal amplifier WC34 is operated at full strength to ensure receiving a control signal.

As seen in FIG. 7, the first remote component RC1 comprises an electrical power source RC15 and a power source holder RC16. The electrical power source RC15 is configured to supply electrical power to the third electronic controller circuitry EC3, the third wireless communicator circuitry WC3, and other electronic parts of the first remote component RC1. The power source holder RC16 is configured to detachably and reattachably hold the electrical power source RC15. The electrical power source RC15 is configured to be detachably and reattachably attached to the power source holder RC16. The power source holder RC16 is configured to be electrically connected to the third electronic controller circuitry EC3, the third wireless communicator circuitry WC3, and other electronic parts of the first remote component RC1. The electrical power source RC15 is configured to supply electrical power to the third electronic controller circuitry EC3, the third wireless communicator circuitry WC3, and other electronic parts of the first remote component RC1 via the power source holder RC16. Examples of the electrical power source RC15 includes a primary battery and a secondary battery. The electrical power source RC15 and the power source holder RC16 can be omitted from the first remote component RC1 if needed or desired. In such modifications, the first remote component RC1 can be powered by another electrical power source such as the electrical power source PS if needed or desired.

As seen in FIG. 8, the second remote component RC2 is configured to be wirelessly communicate with another component such as the second remote component RC2 and the second remote component RC2. The second remote component RC2 comprises fourth wireless communicator circuitry WC4 and fourth electronic controller circuitry EC4. The fourth wireless communicator circuitry WC4 is configured to wirelessly communicate with another wireless communicator circuitry. The fourth electronic controller circuitry EC4 is configured to control the wireless communicator circuitry to wirelessly communicate with another wireless communicator circuitry.

The second remote component RC2 includes a circuit board EC43 and a system bus EC44. The fourth wireless communicator circuitry WC4 and the fourth electronic controller circuitry EC4 are electrically mounted on the circuit board EC43. The fourth electronic controller circuitry EC4 includes a processor EC41 and a memory EC42. The processor EC41 is coupled to the memory EC42. The memory EC42 is coupled to the processor EC41. The processor EC41 and the memory EC42 are electrically mounted on the circuit board EC43. The processor EC41 is electrically connected to the memory EC42 via the circuit board EC43 and the system bus EC44. The memory EC42 is electrically connected to the processor EC41 via the circuit board EC43 and the system bus EC44. For example, the fourth electronic controller circuitry EC4 includes a semiconductor. The processor EC41 includes a semiconductor. The memory EC42 includes a semiconductor. However, the fourth electronic controller circuitry EC4 can be free of a semiconductor if needed or desired. The processor EC41 can be free of a semiconductor if needed or desired. The memory EC42 can be free of a semiconductor if needed or desired.

For example, the processor EC41 includes at least one of a central processing unit (CPU), a micro processing unit (MPU), and a memory controller. The memory EC42 is electrically connected to the processor EC41. For example, the memory EC42 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC42 includes storage areas each having an address. The processor EC41 is configured to control the memory EC42 to store data in the storage areas of the memory EC42 and reads data from the storage areas of the memory EC42. The processor EC41 can also be referred to as a hardware processor EC41 or a processor circuit or circuitry EC41. The memory EC42 can also be referred to as a hardware memory EC42 or a memory circuit or circuitry EC42. The memory EC42 can also be referred to as a non-transitory computer-readable storage medium EC42. Namely, the fourth electronic controller circuitry EC4 includes the non-transitory computer-readable storage medium EC42.

The fourth electronic controller circuitry EC4 is configured to execute at least one control algorithm of the second remote component RC2. For example, the fourth electronic controller circuitry EC4 is programed to execute at least one control algorithm of the second remote component RC2. The memory EC42 stores at least one program including at least one program instruction. The at least one program is read into the processor EC41, and thereby the at least one control algorithm of the second remote component RC2 is executed based on the at least one program.

The structure of the fourth electronic controller circuitry EC4 is not limited to the above structure. The structure of the fourth electronic controller circuitry EC4 is not limited to the processor EC41 and the memory EC42. The fourth electronic controller circuitry EC4 can be realized by hardware alone or a combination of hardware and software. In the present embodiment, the processor EC41 and the memory EC42 are integrated as a single chip such as an application specific integrated circuit (ASIC) or a field programmable gate array (FPGA). However, the processor EC41 and the memory EC42 can be separate chips if needed or desired. The fourth electronic controller circuitry EC4 can include the processor EC41, the memory EC42, the circuit board EC43, and the system bus EC44 if needed or desired. The fourth electronic controller circuitry EC4 can be at least two electronic controller circuits which are separately provided.

The fourth electronic controller circuitry EC4 can include at least two electronic controller circuits which are separately provided. The at least one control algorithm of the second remote component RC2 can be executed by the at least two electronic controller circuits if needed or desired. The fourth electronic controller circuitry EC4 can include at least two processors which are separately provided. The fourth electronic controller circuitry EC4 can include at least two memories which are separately provided. The at least one control algorithm of the second remote component RC2 can be executed by the at least two processors if needed or desired. The at least one control algorithm of the second remote component RC2 can be stored in the at least two memories if needed or desired. The fourth electronic controller circuitry EC4 can include at least two circuit boards which are separately provided if needed or desired. The fourth electronic controller circuitry EC4 can include at least two system buses which are separately provided if needed or desired.

The fourth wireless communicator circuitry WC4 is electrically mounted on the circuit board EC43. The fourth wireless communicator circuitry WC4 is electrically connected to the processor EC41 and the memory EC42 with the circuit board EC43 and the system bus EC44. For example, the fourth wireless communicator circuitry WC4 includes fourth signal transmitting circuitry WC41, fourth signal receiving circuitry WC42, and fourth antenna circuitry WC43. The fourth signal transmitting circuitry WC41 is electrically connected to the fourth antenna circuitry WC43. The fourth signal receiving circuitry WC42 is electrically connected to the fourth antenna circuitry WC43.

The fourth wireless communicator circuitry WC4 is configured to transmit wireless signals via the fourth antenna circuitry WC43. The fourth wireless communicator circuitry WC4 is configured to superimpose digital signals on carrier wave using a predetermined wireless communication protocol to wirelessly transmit signals. In the present embodiment, the fourth wireless communicator circuitry WC4 is configured to encrypt signals using a cryptographic key to generate encrypted wireless signals.

The fourth wireless communicator circuitry WC4 is configured to receive wireless signals via the fourth antenna circuitry WC43. In the present embodiment, the fourth wireless communicator circuitry WC4 is configured to decode the wireless signals to recognize signals transmitted from other wireless communicators. The fourth wireless communicator circuitry WC4 is configured to decrypt the wireless signals using the cryptographic key.

The fourth wireless communicator circuitry WC4 includes a fourth signal amplifier WC44. The fourth signal amplifier WC44 is coupled to the fourth signal transmitting circuitry WC41, the fourth signal receiving circuitry WC42, and the fourth antenna circuitry WC43. The fourth signal amplifier WC44 is configured to selectively amplify the signals of the fourth antenna circuitry WC43. The fourth signal amplifier WC44 can be controlled by the fourth electronic controller circuitry EC4. The fourth electronic controller circuitry EC4 is configured to control the fourth signal amplifier WC44 such that the fourth signal amplifier WC44 operates in a fourth low power consumption state in a state where the second remote component RC2 is in the wireless signal listening mode. The fourth electronic controller circuitry EC4 is configured to control the fourth signal amplifier WC44 such that the fourth signal amplifier WC44 operates in a fourth high power consumption state in a state where the second remote component RC2 is in the fourth pairing mode. The fourth low power consumption state has a lower power consumption than the fourth high power consumption state. For example, the fourth signal amplifier WC44 operates intermittently, sleeps or turns off in the fourth low power consumption state where the second remote component RC2 is in the wireless signal listening mode. In this way, the fourth wireless communicator circuitry WC4 is less likely incorrectly paired by reducing the signal strength where the second remote component RC2 is in the fourth pairing mode. On the other hand, in all other modes, the fourth signal amplifier WC44 is operated at full strength to ensure receiving a control signal.

The second remote component RC2 comprises an electrical power source RC25 and a power source holder RC26. The electrical power source RC25 is configured to supply electrical power to the fourth electronic controller circuitry EC4, the fourth wireless communicator circuitry WC4, and other electronic parts of the second remote component RC2. The power source holder RC26 is configured to detachably and reattachably hold the electrical power source RC25. The electrical power source RC25 is configured to be detachably and reattachably attached to the power source holder RC26. The power source holder RC26 is configured to be electrically connected to the fourth electronic controller circuitry EC4, the fourth wireless communicator circuitry WC4, and other electronic parts of the second remote component RC2. The electrical power source RC25 is configured to supply electrical power to the fourth electronic controller circuitry EC4, the fourth wireless communicator circuitry WC4, and other electronic parts of the second remote component RC2 via the power source holder RC26. Examples of the electrical power source RC25 includes a primary battery and a secondary battery. The electrical power source RC25 and the power source holder RC26 can be omitted from the second remote component RC2 if needed or desired. In such modifications, the second remote component RC2 can be powered by another electrical power source such as the electrical power source PS if needed or desired.

As seen in FIG. 7, the trigger input device TG is configured to be wirelessly communicate with another component such as the human-powered vehicle component BC1, the additional human-powered vehicle component BC2, the first remote component RC1, and the second remote component RC2. The trigger input device TG comprises fifth wireless communicator circuitry WC5 and fifth electronic controller circuitry EC5. The fifth wireless communicator circuitry WC5 is configured to wirelessly communicate with another wireless communicator circuitry. The fifth electronic controller circuitry EC5 is configured to control the fifth wireless communicator circuitry WC5 to wirelessly communicate with another wireless communicator circuitry.

The trigger input device TG includes a circuit board EC53 and a system bus EC54. The fifth wireless communicator circuitry WC5 and the fifth electronic controller circuitry EC5 are electrically mounted on the circuit board EC53. The fifth electronic controller circuitry EC5 includes a processor EC51 and a memory EC52. The processor EC51 is coupled to the memory EC52. The memory EC52 is coupled to the processor EC51. The processor EC51 and the memory EC52 are electrically mounted on the circuit board EC53. The processor EC51 is electrically connected to the memory EC52 via the circuit board EC53 and the system bus EC54. The memory EC52 is electrically connected to the processor EC51 via the circuit board EC53 and the system bus EC54. For example, the fifth electronic controller circuitry EC5 includes a semiconductor. The processor EC51 includes a semiconductor. The memory EC52 includes a semiconductor. However, the fifth electronic controller circuitry EC5 can be free of a semiconductor if needed or desired. The processor EC51 can be free of a semiconductor if needed or desired. The memory EC52 can be free of a semiconductor if needed or desired.

For example, the processor EC51 includes at least one of a central processing unit (CPU), a micro processing unit (MPU), and a memory controller. The memory EC52 is electrically connected to the processor EC51. For example, the memory EC52 includes at least one of a volatile memory and a non-volatile memory. Examples of the volatile memory include a random-access memory (RAM) and a dynamic random-access memory (DRAM). Examples of the non-volatile memory include a read only memory (ROM), an electrically erasable programmable ROM (EEPROM), and a magnetic disc. The memory EC52 includes storage areas each having an address. The processor EC51 is configured to control the memory EC52 to store data in the storage areas of the memory EC52 and reads data from the storage areas of the memory EC52. The processor EC51 can also be referred to as a hardware processor EC51 or a processor circuit or circuitry EC51. The memory EC52 can also be referred to as a hardware memory EC52 or a memory circuit or circuitry EC52. The memory EC52 can also be referred to as a non-transitory computer-readable storage medium EC52. Namely, the fifth electronic controller circuitry EC5 includes the non-transitory computer-readable storage medium EC52.

The fifth electronic controller circuitry EC5 is configured to execute at least one control algorithm of the trigger input device TG. For example, the fifth electronic controller circuitry EC5 is programed to execute at least one control algorithm of the trigger input device TG. The memory EC52 stores at least one program including at least one program instruction. The at least one program is read into the processor EC51, and thereby the at least one control algorithm of the trigger input device TG is executed based on the at least one program.

The structure of the fifth electronic controller circuitry EC5 is not limited to the above structure. The structure of the fifth electronic controller circuitry EC5 is not limited to the processor EC51 and the memory EC52. The fifth electronic controller circuitry EC5 can be realized by hardware alone or a combination of hardware and software. In the present embodiment, the processor EC51 and the memory EC52 are integrated as a single chip such as an application specific integrated circuit (ASIC) or a field programmable gate array (FPGA). However, the processor EC51 and the memory EC52 can be separate chips if needed or desired. The fifth electronic controller circuitry EC5 can include the processor EC51, the memory EC52, the circuit board EC53, and the system bus EC54 if needed or desired.

The fifth electronic controller circuitry EC5 can include at least two electronic controller circuits which are separately provided. The at least one control algorithm of the trigger input device TG can be executed by the at least two electronic controller circuits if needed or desired. The fifth electronic controller circuitry EC5 can include at least two processors which are separately provided. The fifth electronic controller circuitry EC5 can include at least two memories which are separately provided. The at least one control algorithm of the trigger input device TG can be executed by the at least two processors if needed or desired. The at least one control algorithm of the trigger input device TG can be stored in the at least two memories if needed or desired. The fifth electronic controller circuitry EC5 can include at least two circuit boards which are separately provided if needed or desired. The fifth electronic controller circuitry EC5 can include at least two system buses which are separately provided if needed or desired.

The fifth wireless communicator circuitry WC5 is electrically mounted on the circuit board EC53. The fifth wireless communicator circuitry WC5 is electrically connected to the processor EC51 and the memory EC52 with the circuit board EC53 and the system bus EC54. For example, the fifth wireless communicator circuitry WC5 includes fifth signal transmitting circuitry WC51, fifth signal receiving circuitry WC52, and fifth antenna circuitry WC53. The fifth signal transmitting circuitry WC51 is electrically connected to the fifth antenna circuitry WC53. The fifth signal receiving circuitry WC52 is electrically connected to the fifth antenna circuitry WC53.

The fifth wireless communicator circuitry WC5 is configured to transmit wireless signals via the fifth antenna circuitry WC53. The fifth wireless communicator circuitry WC5 is configured to superimpose digital signals on carrier wave using a predetermined wireless communication protocol to wirelessly transmit signals. In the present embodiment, the fifth wireless communicator circuitry WC5 is configured to encrypt signals using a cryptographic key to generate encrypted wireless signals.

The fifth wireless communicator circuitry WC5 is configured to receive wireless signals via the fifth antenna circuitry WC53. In the present embodiment, the fifth wireless communicator circuitry WC5 is configured to decode the wireless signals to recognize signals transmitted from other wireless communicators. The fifth wireless communicator circuitry WC5 is configured to decrypt the wireless signals using the cryptographic key.

The fifth wireless communicator circuitry WC5 includes a fifth signal amplifier WC54. The fifth signal amplifier WC54 is coupled to the fifth signal transmitting circuitry WC51, the fifth signal receiving circuitry WC52, and the fifth antenna circuitry WC53. The fifth signal amplifier WC54 is configured to selectively amplify the signals of the fifth antenna circuitry WC53. The fifth signal amplifier WC54 can be controlled by the fifth electronic controller circuitry EC5.

The trigger input device TG comprises an electrical power source TG5 and a power source holder TG6. The electrical power source TG5 is configured to supply electrical power to the display TG1, the touch panel TG2, and other electronic parts of the trigger input device TG. The power source holder TG6 is configured to detachably and reattachably hold the electrical power source TG5. The electrical power source TG5 is configured to be detachably and reattachably attached to the power source holder TG6. The power source holder TG6 is configured to be electrically connected to the display TG1, the touch panel TG2, and other electronic parts of the trigger input device TG. The electrical power source TG5 is configured to supply electrical power to the display TG1, the touch panel TG2, and other electronic parts of the trigger input device TG via the power source holder TG6. Examples of the electrical power source TG5 includes a primary battery and a secondary battery. The electrical power source TG5 and the power source holder TG6 can be omitted from the trigger input device TG if needed or desired. In such modifications, the trigger input device TG can be powered by another electrical power source such as the electrical power source PS if needed or desired.

In the present application, the term “wireless communicator” or “wireless communicator circuitry” as used herein includes a receiver, a transmitter, a transceiver, a transmitter-receiver, and contemplates any device or devices, separate or combined, capable of transmitting and/or receiving wireless communication signals, including shift signals or control, command or other signals related to some function of the component being controlled. Here, at least one of the first wireless communicator circuitry WC1, the second wireless communicator circuitry WC2, the third wireless communicator circuitry WC3, the fourth wireless communicator circuitry WC4, and the fifth wireless communicator circuitry WC5 is configured to at least receive a wireless signal. For example, each of the first wireless communicator circuitry WC1, the second wireless communicator circuitry WC2, the third wireless communicator circuitry WC3, the fourth wireless communicator circuitry WC4, and the fifth wireless communicator circuitry WC5 includes a two-way wireless transceiver that conducts two-way wireless communications using the wireless receiver for wirelessly receiving signals and a wireless transmitter for wirelessly transmitting signals.

Each of the first wireless communicator circuitry WC1, the second wireless communicator circuitry WC2, the third wireless communicator circuitry WC3, the fourth wireless communicator circuitry WC4, and the fifth wireless communicator circuitry WC5 can use radio frequency (RF) signals, ultra-wide band communication signals, radio frequency identification (RFID), Wi-Fi (registered trademark), Zigbee (registered trademark), ANT+ (registered trademark), or Bluetooth (registered trademark) or any other type of communication protocols suitable for short range wireless communications as understood in the human-powered vehicle field.

It should also be understood that each of the first wireless communicator circuitry WC1, the second wireless communicator circuitry WC2, the third wireless communicator circuitry WC3, the fourth wireless communicator circuitry WC4, and the fifth wireless communicator circuitry WC5 can transmit the signals at a particular or randomly selected frequency and/or with an identifier such as a particular code, to distinguish the wireless signal from other wireless signals. In this way, each of the human-powered vehicle component BC1, the additional human-powered vehicle component BC2, the first remote component RC1, the second remote component RC2, and the trigger input device TG can recognize which signals are to be acted upon and which signals are not to be acted upon. Thus, each of the human-powered vehicle component BC1, the additional human-powered vehicle component BC2, the first remote component RC1, the second remote component RC2, and the trigger input device TG can ignore the signals from other wireless communicators of other electric devices.

The first wireless communicator circuitry WC1 is configured to be paired with at least one of the second wireless communicator circuitry WC2, the third wireless communicator circuitry WC3, the fourth wireless communicator circuitry WC4, and the fifth wireless communicator circuitry WC5. The second wireless communicator circuitry WC2 is configured to be paired with at least one of the first wireless communicator circuitry WC1, the third wireless communicator circuitry WC3, the fourth wireless communicator circuitry WC4, and the fifth wireless communicator circuitry WC5. The third wireless communicator circuitry WC3 is configured to be paired with at least one the first wireless communicator circuitry WC1, the second wireless communicator circuitry WC2, the fourth wireless communicator circuitry WC4, and the fifth wireless communicator circuitry WC5. The fourth wireless communicator circuitry WC4 is configured to be paired with at least one of the first wireless communicator circuitry WC1, the second wireless communicator circuitry WC2, the third wireless communicator circuitry WC3, and the fifth wireless communicator circuitry WC5. The fifth wireless communicator circuitry WC5 is configured to be paired with at least one of the first wireless communicator circuitry WC1, the second wireless communicator circuitry WC2, the third wireless communicator circuitry WC3, and the fourth wireless communicator circuitry WC4.

The human-powered vehicle component BC1 has a first pairing mode. The first electronic controller circuitry EC1 is configured to cause the human-powered vehicle component BC1 to enter the first pairing mode. In the first pairing mode, the first electronic controller circuitry EC1 is configured to execute pairing between the human-powered vehicle component BC1 and another component such as the additional human-powered vehicle component BC2, the first remote component RC1, the second remote component RC2, and the trigger input device TG. As will be described later, the human-powered vehicle component BC1 is configured to enter the first pairing mode based on the pairing trigger signal TS of the trigger input device TG.

The additional human-powered vehicle component BC2 has a second pairing mode. The second electronic controller circuitry EC2 is configured to cause the additional human-powered vehicle component BC2 to enter the second pairing mode. In the second pairing mode, the second electronic controller circuitry EC2 is configured to execute pairing between the additional human-powered vehicle component BC2 and another human-powered vehicle component such as the human-powered vehicle component BC1, the first remote component RC1, the second remote component RC2, and the trigger input device TG. As will be described later, the human-powered vehicle component BC1 is configured to enter the second pairing mode based on the pairing trigger signal TS of the trigger input device TG.

The first remote component RC1 has a third pairing mode. The third electronic controller circuitry EC3 is configured to cause the first remote component RC1 to enter the third pairing mode. In the third pairing mode, the third electronic controller circuitry EC3 is configured to execute pairing between the first remote component RC1 and another component such as the human-powered vehicle component BC1, the additional human-powered vehicle component BC2, the second remote component RC2, and the trigger input device TG. For example, the first remote component RC1 is configured to enter the third pairing mode based on a first trigger operation applied to the first remote component RC1.

The first trigger operation includes at least one of: the first user input U11 received by the first input device SW1; providing electrical power to the first remote component RC1; connecting an electrical power source to the first remote component RC1; connecting an electrical cable connected to another device; operating a device connected to or included in the first remote component RC1; and providing an output from a sensor to the first remote component RC1. Examples of the output from the sensor includes acceleration detected by an acceleration sensor, a cadence detected by a cadence sensor, and a vehicle speed detected by a speed sensor. For example, the first remote component RC1 is configured to enter the third pairing mode in response to the first user input U11 of the first input device SW1.

The second remote component RC2 has a fourth pairing mode. The fourth electronic controller circuitry EC4 is configured to cause the second remote component RC2 to enter the fourth pairing mode. In the fourth pairing mode, the fourth electronic controller circuitry EC4 is configured to execute pairing between the second remote component RC2 and another component such as the human-powered vehicle component BC1, the additional human-powered vehicle component BC2, the first remote component RC1, and the trigger input device TG. For example, the second remote component RC2 is configured to enter the fourth pairing mode based on a second trigger operation applied to the second remote component RC2.

The second trigger operation includes at least one of: the second user input U21 received by the second input device SW2; providing electrical power to the second remote component RC2; connecting an electrical power source to the second remote component RC2; connecting an electrical cable connected to another device; operating a device connected to or included in the second remote component RC2; and providing an output from a sensor to the second remote component RC2. Examples of the output from the sensor includes acceleration detected by an acceleration sensor, a cadence detected by a cadence sensor, and a vehicle speed detected by a speed sensor. For example, the second remote component RC2 is configured to enter the fourth pairing mode in response to the second user input U21 of the second input device SW2.

As seen in FIG. 7, the trigger input device TG is configured to transmit the pairing trigger signal TS in response to the user trigger input UT to at least one of the at least two human-powered vehicle components BC. The trigger input device TG is configured to transmit the pairing trigger signal TS in response to the user trigger input UT to at least one of the human-powered vehicle component BC1, the additional human-powered vehicle component BC2, the first remote component RC1, and the second remote component RC2. The pairing trigger signal TS has no specified recipient.

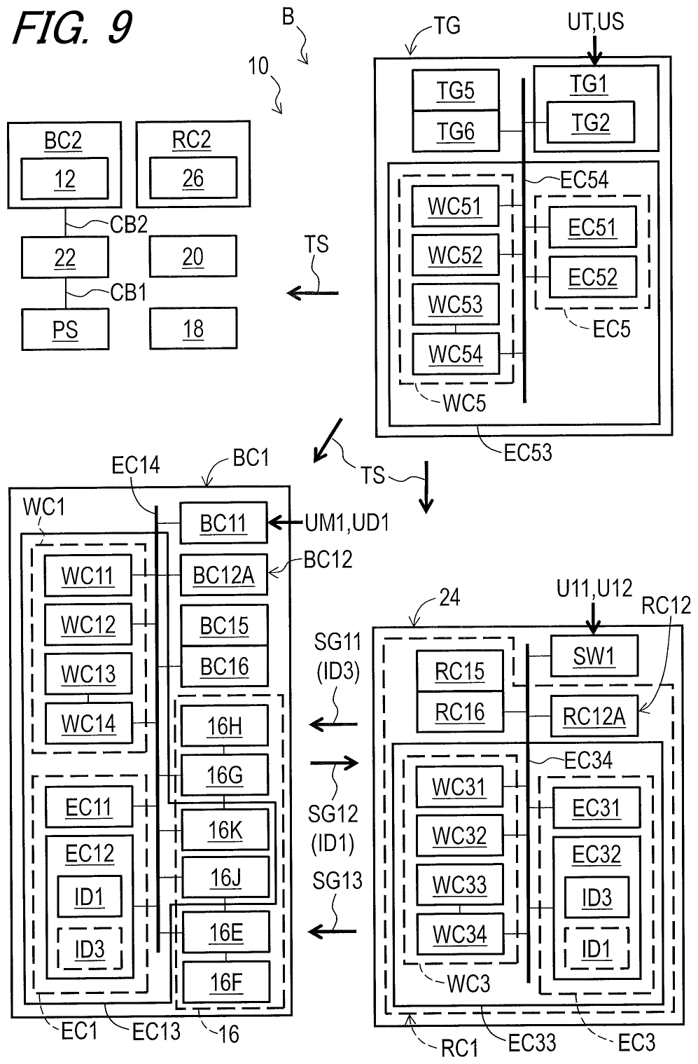

As seen in FIG. 9, the first wireless communicator circuitry WC1 is configured to wirelessly receive the pairing trigger signal TS generated in response to the user trigger input UT of the trigger input device TG. The first electronic controller circuitry EC1 is configured to cause the human-powered vehicle component BC1 to enter the first pairing mode in response to the pairing trigger signal TS.

The human-powered vehicle component BC1 has a wireless signal listening mode in which the first electronic controller circuitry EC1 detects the pairing trigger signal TS via the first wireless communicator circuitry WC1. The first wireless communicator circuitry WC1 is configured to detect the pairing trigger signal TS in the wireless signal listening mode. The wireless signal listening mode is different from the first pairing mode. The wireless signal listening mode can be referred to as a first wireless signal listening mode.

The first electronic controller circuitry EC1 is configured to cause, in response to a trigger, the human-powered vehicle component BC1 to enter the wireless signal listening mode. The first electronic controller circuitry EC1 is configured to cause the human-powered vehicle component BC1 to enter the first pairing mode in a case where the first electronic controller circuitry EC1 detects the pairing trigger signal TS via the first wireless communicator circuitry WC1 in the wireless signal listening mode.

For example, the trigger includes at least one of: providing electrical power to the human-powered vehicle component BC1; connecting an electrical power source to the human-powered vehicle component BC1; connecting an electrical cable connected to the additional human-powered vehicle component BC2; operating an additional control device configured to control the additional human-powered vehicle component BC2; and providing an output from a sensor to the human-powered vehicle component BC1. Examples of the output from the sensor includes acceleration detected by an acceleration sensor, a cadence detected by a cadence sensor, and a vehicle speed detected by a speed sensor. The sensor can be provided to the human-powered vehicle B. The sensor can be provided to the human-powered vehicle component BC1 or another device of the human-powered vehicle B.

In the present embodiment, the trigger includes: providing electrical power to the human-powered vehicle component BC1; connecting a power source to the human-powered vehicle component BC1; connecting the electrical cable connected to the additional human-powered vehicle component BC2; operating the additional control device configured to control the additional human-powered vehicle component BC2; and providing the output from a sensor to the human-powered vehicle component BC1. However, the trigger can include at least one of: providing electrical power to the human-powered vehicle component BC1; connecting a power source to the human-powered vehicle component BC1; connecting the electrical cable connected to the additional human-powered vehicle component BC2; operating the additional control device configured to control the additional human-powered vehicle component BC2; and providing the output from a sensor to the human-powered vehicle component BC1 if needed or desired.

As seen in FIG. 9, the first remote component RC1 is configured to wirelessly transmit a first pairing request signal SG11 in the third pairing mode in response to the first user input U11 received by the first input device SW1. For example, the third electronic controller circuitry EC3 is configured to cause the first remote component RC1 to enter the third pairing mode in response to the first user input U11. After entering the third pairing mode, the third electronic controller circuitry EC3 is configured to control the third wireless communicator circuitry to wirelessly transmit the first pairing request signal SG11 at predetermined intervals. The first pairing request signal SG11 can be referred to as a pairing request signal SG11.

The first electronic controller circuitry EC1 is configured to establish, in the first pairing mode, wireless communication between the human-powered vehicle component BC1 and the first remote component RC1 that sent the first pairing request signal SG11. For example, the wireless communication between the human-powered vehicle component BC1 and the first remote component RC1 includes at least one of wireless connection and pairing between the human-powered vehicle component BC1 and the first remote component RC1. The first electronic controller circuitry EC1 is configured to execute pairing between the human-powered vehicle component BC1 and another device in the first pairing mode.

The first wireless communicator circuitry WC1 is configured to wirelessly receive, in the first pairing mode, the first pairing request signal SG11 generated in response to the first user input U11 of the first input device SW1. The pairing trigger signal TS is distinguishable from the first pairing request signal SG11. The first electronic controller circuitry EC1 is configured to detect the pairing trigger signal TS in the wireless signal listening mode. However, the first electronic controller circuitry EC1 is configured to ignore or not detect the first pairing request signal SG11 in the wireless signal listening mode.

For example, the first pairing request signal SG11 includes an advertisement signal having no specified recipient. The first pairing request signal SG11 can also be referred to as a first advertising signal. The first pairing request signal SG11 includes pairing information ID3 of the first remote component RC1. The third electronic controller circuitry EC3 is configured to store the pairing information ID3 in the memory EC32. The pairing information ID3 includes information relating to the first remote component RC1. The pairing information ID3 includes at least one of identification information and cryptographic key information. The identification information includes a unique number indicating the first remote component RC1. Examples of the unique number include an address of the first remote component RC1. The cryptographic key information includes a cryptographic key. Another wireless communicator encrypts information using the cryptographic key information, and the first remote component RC1 decrypts the encrypted information using the cryptographic key information. The cryptographic key information of the pairing information ID3 corresponds to a communication protocol used in the human-powered vehicle component BC1 and the first remote component RC1.

The third electronic controller circuitry EC3 is configured to wirelessly transmit the first pairing request signal SG11 at predetermined intervals in the third pairing mode. The first wireless communicator circuitry WC1 is configured to detect wireless signals such as the first pairing request signal SG11 in the first pairing mode. Thus, the first wireless communicator circuitry WC1 detects the first pairing request signal SG11 in the first pairing mode in a case where the human-powered vehicle component BC1 and the first remote component RC1 are in the first pairing mode and the third pairing mode, respectively. The first electronic controller circuitry EC1 is configured to store, in the memory EC12, the pairing information ID3 included in the first pairing request signal SG11 in a case where the first wireless communicator circuitry WC1 detects the first pairing request signal SG11 in the first pairing mode. For example, the first electronic controller circuitry EC1 is configured to store, in the memory EC12, the identification information included in the pairing information ID3 included in the first pairing request signal SG11 in the case where the first wireless communicator circuitry WC1 detects the first pairing request signal SG11 in the first pairing mode.

The first wireless communicator circuitry WC1 is configured to wirelessly transmit a first pairing response signal SG12 in response to the first pairing request signal SG11. The third wireless communicator circuitry WC3 of the first remote component RC1 is configured to detect the first pairing response signal SG12 transmitted from the first wireless communicator circuitry WC1 in the third pairing mode. The first pairing response signal SG12 can be referred to as a pairing response signal SG12.

The first pairing response signal SG12 includes first pairing information ID1 of the human-powered vehicle component BC1. The first electronic controller circuitry EC1 is configured to store the first pairing information ID1 in the memory EC12. The first pairing information ID1 includes at least one of first identification information and first cryptographic key information. In the present embodiment, for example, the first pairing response signal SG12 includes the first identification information of the first pairing information ID1. The first identification information includes a unique number indicating the human-powered vehicle component BC1. Examples of the unique number include an address of the human-powered vehicle component BC1. The first cryptographic key information includes a first cryptographic key. Another wireless communicator encrypts information using the first cryptographic key information, and the first wireless communicator circuitry WC1 decrypts the encrypted information using the first cryptographic key information. The third electronic controller circuitry EC3 is configured to store the first pairing information ID1 in the memory EC32. The first pairing information ID1 can also be referred to as pairing information ID1. The first cryptographic key information corresponds to the communication protocol used in the human-powered vehicle component BC1 and the first remote component RC1.

In the present embodiment, the first wireless communicator circuitry WC1 is configured to automatically transmit the first pairing response signal SG12 in response to the first pairing request signal SG11 in the first pairing mode. However, the first wireless communicator circuitry WC1 can be configured to wirelessly transmit the first pairing response signal SG12 based on another trigger other than the first pairing request signal SG11 if needed or desired. For example, the user interface BC11 can be configured to receive a user operation indicating transmission of the first pairing response signal SG12. The first wireless communicator circuitry WC1 can be configured to transmit the first pairing response signal SG12 in response to the user operation in a state where the first wireless communicator circuitry WC1 receives the first pairing request signal SG11.

The third wireless communicator circuitry WC3 is configured to detect, in the third pairing mode, the first pairing response signal SG12 transmitted from the first wireless communicator circuitry WC1. The third electronic controller circuitry EC3 is configured to store, in the memory EC32, the first pairing information ID1 included in the first pairing response signal SG12 in a case where the third wireless communicator circuitry WC3 detects the first pairing response signal SG12 in the third pairing mode. For example, the third electronic controller circuitry EC3 is configured to store, in the memory EC32, the first identification information and the first cryptographic key information which are included in the first pairing information ID1 included in the first pairing response signal SG12 in a case where the third wireless communicator circuitry WC3 detects the first pairing response signal SG12 in the third pairing mode.

Accordingly, the human-powered vehicle component BC1 and the first remote component RC1 are paired during the pairing process. The first electronic controller circuitry EC1 can be configured to cause the human-powered vehicle component BC1 to exit the first pairing mode and to enter a first control mode after the completion of the pairing process. For example, the first electronic controller circuitry EC1 can be configured to cause the human-powered vehicle component BC1 to exit the first pairing mode and to enter the first control mode after the first wireless communicator circuitry WC1 wirelessly transmits the first pairing response signal SG12 in the first pairing mode. In the first control mode, the human-powered vehicle component BC1 is controlled based on the first signal CS1 transmitted from the first remote component RC1 of the first operating device 24. The first signal CS1 is encrypted by the third wireless communicator circuitry WC3 using the cryptographic key information of the first pairing information ID1. Thus, the human-powered vehicle component BC1 can decrypt the encrypted information included in the first signal CS1 while another component, which is not paired with the human-powered vehicle component BC1, cannot decrypt the encrypted information included in the first signal CS1.

The first electronic controller circuitry EC1 can be configured to cause the human-powered vehicle component BC1 to exit the first pairing mode based on a condition other than the completion of the pairing process. For example, the user interface BC11 can be configured to receive the user operation including a mode reset user input UM1. Namely, the user interface BC11 is configured to receive the mode reset user input UM1. The first electronic controller circuitry EC1 can be configured to cause the human-powered vehicle component BC1 to exit the first pairing mode in response to the mode reset user input UM1 received by the user interface BC11. Alternatively, the first electronic controller circuitry EC1 can be configured to cause the human-powered vehicle component BC1 to exit the first pairing mode after a predetermined time as elapsed from entering the first pairing mode. In this modification, the first electronic controller circuitry EC1 can be configured to cause the human-powered vehicle component BC1 to enter the wireless signal listening mode after exiting the first pairing mode.

The third electronic controller circuitry EC3 can be configured to cause the first remote component RC1 to exit the first pairing mode and to enter a third control mode after the completion of the pairing process. For example, the third electronic controller circuitry EC3 can be configured to cause the first remote component RC1 to exit the third pairing mode and to enter the third control mode after the third wireless communicator circuitry WC3 wirelessly transmits the first pairing request signal SG11 in the third pairing mode or after the third wireless communicator circuitry WC3 wirelessly receives the first pairing response signal SG12 in the third pairing mode. In the third control mode, the first remote component RC1 is configured to wirelessly transmit the first signal CS1 to the human-powered vehicle component BC1.

Furthermore, the third electronic controller circuitry EC3 can be configured to transmit a first pairing signal SG13 via the third wireless communicator circuitry WC3 in response to the first pairing response signal SG12 in the third pairing mode. The first pairing signal SG13 is generated in response to the first pairing response signal SG12. In this modification, the first wireless communicator circuitry WC1 can be configured to receive the first pairing signal SG13 from the first remote component RC1. For example, the first pairing signal SG13 includes pairing information ID3 of the first remote component RC1. The first electronic controller circuitry EC1 is configured to store, in the memory EC12, the pairing information ID3 included in the first pairing signal SG13 in a case where the first wireless communicator circuitry WC1 detects the first pairing signal SG13 in the first pairing mode. For example, the first electronic controller circuitry EC1 is configured to store, in the memory EC12, the cryptographic key information or both the identification information and the cryptographic key information of the pairing information ID3 included in the first pairing signal SG13.

The third electronic controller circuitry EC3 can be configured to cause the first remote component RC1 to exit the third pairing mode and to enter the third control mode after the third wireless communicator circuitry WC3 wirelessly transmits the first pairing signal SG13 in the third pairing mode. The first electronic controller circuitry EC1 can be configured to cause the human-powered vehicle component BC1 to exit the third pairing mode and to enter the first control mode after the first wireless communicator circuitry WC1 wirelessly receives the first pairing signal SG13 in the third pairing mode. The first pairing signal SG13 can also be referred to as a pairing signal SG13.

The third electronic controller circuitry EC3 can be configured to cause the first remote component RC1 to exit the third pairing mode based on a condition other than the completion of the pairing process. For example, the first input device SW1 can be configured to receive the user operation including a mode reset user input UM3. Namely, the first input device SW1 is configured to receive the mode reset user input UM3. The third electronic controller circuitry EC3 can be configured to cause the first remote component RC1 to exit the third pairing mode in response to the mode reset user input UM3 received by the first input device SW1. Alternatively, the third electronic controller circuitry EC3 can be configured to cause the first remote component RC1 to exit the third pairing mode after a predetermined time as elapsed from entering the third pairing mode. In this modification, the third electronic controller circuitry EC3 can be configured to cause the first remote component RC1 to enter the wireless signal listening mode after exiting the third pairing mode.

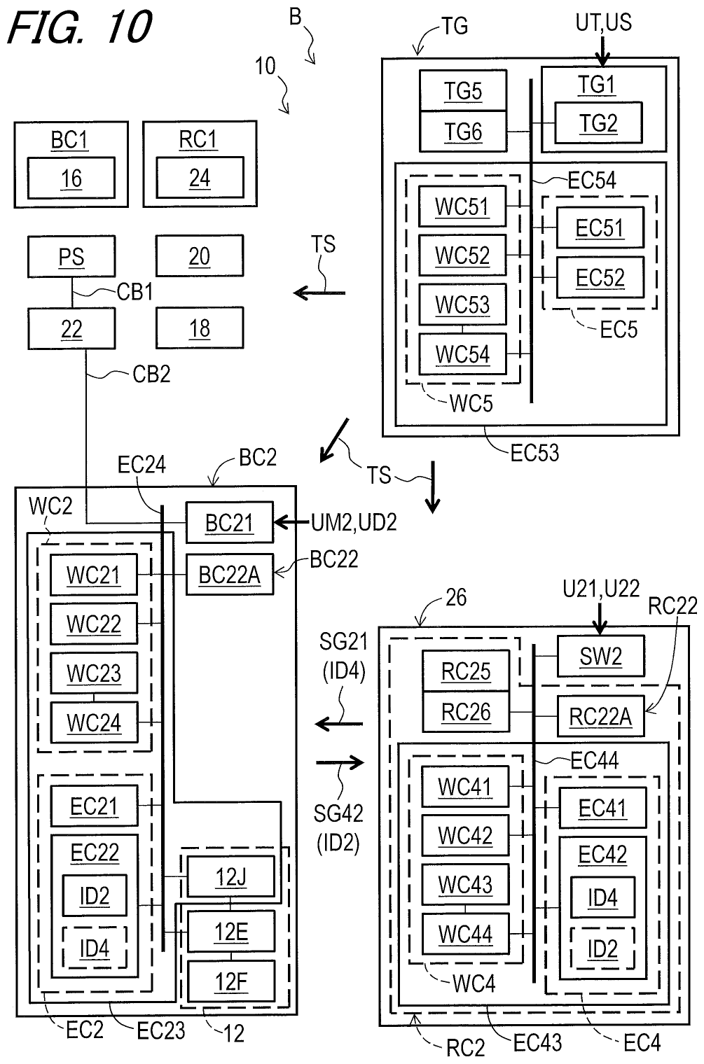

As seen in FIG. 10, the second wireless communicator circuitry WC2 is configured to wirelessly receive the pairing trigger signal TS generated in response to the user trigger input UT. The second electronic controller circuitry EC2 is configured to cause the additional human-powered vehicle component BC2 to enter the second pairing mode in response to the pairing trigger signal TS.

The additional human-powered vehicle component BC2 has a second wireless signal listening mode in which the second electronic controller circuitry EC2 detects the pairing trigger signal TS via the second wireless communicator circuitry WC2. The second wireless communicator circuitry WC2 is configured to detect the pairing trigger signal TS in the second wireless signal listening mode. The second wireless signal listening mode is different from the second pairing mode.

The second electronic controller circuitry EC2 is configured to cause, in response to a trigger, the additional human-powered vehicle component BC2 to enter the second wireless signal listening mode. The second electronic controller circuitry EC2 is configured to cause the additional human-powered vehicle component BC2 to enter the second pairing mode in a case where the second electronic controller circuitry EC2 detects the pairing trigger signal TS via the second wireless communicator circuitry WC2 in the second wireless signal listening mode.

For example, the trigger includes at least one of: providing electrical power to the additional human-powered vehicle component BC2; connecting an electrical power source to the additional human-powered vehicle component BC2; connecting an electrical cable connected to the human-powered vehicle component BC1; operating an additional control device configured to control the human-powered vehicle component BC1; and providing an output from a sensor to the additional human-powered vehicle component BC2. Examples of the output from the sensor includes acceleration detected by an acceleration sensor, a cadence detected by a cadence sensor, and a vehicle speed detected by a speed sensor.

In the present embodiment, the trigger includes: providing electrical power to the additional human-powered vehicle component BC2; connecting a power source to the additional human-powered vehicle component BC2; connecting the electrical cable connected to the human-powered vehicle component BC1; operating the additional control device configured to control the human-powered vehicle component BC1; and providing the output from the sensor to the additional human-powered vehicle component BC2. However, the trigger can include at least one of: providing electrical power to the additional human-powered vehicle component BC2; connecting a power source to the additional human-powered vehicle component BC2; connecting the electrical cable connected to the human-powered vehicle component BC1; operating the additional control device configured to control the human-powered vehicle component BC1; and providing the output from the sensor to the additional human-powered vehicle component BC2 if needed or desired.

As seen in FIG. 10, the second remote component RC2 is configured to wirelessly transmit a second pairing request signal SG21 in the fourth pairing mode in response to the second user input U21 received by the second input device SW2. For example, the fourth electronic controller circuitry EC4 is configured to cause the second remote component RC2 to enter the fourth pairing mode in response to the second user input U21. After entering the fourth pairing mode, the fourth electronic controller circuitry EC4 is configured to control the fourth wireless communicator circuitry to wirelessly transmit the second pairing request signal SG21 at predetermined intervals. The second pairing request signal SG21 can be referred to as a pairing request signal SG21.

The second electronic controller circuitry EC2 is configured to establish, in the second pairing mode, wireless communication between the additional human-powered vehicle component BC2 and the second remote component RC2 that sent a second pairing request signal SG21. For example, the wireless communication between the additional human-powered vehicle component BC2 and the second remote component RC2 includes at least one of wireless connection and pairing between the additional human-powered vehicle component BC2 and the second remote component RC2. The second electronic controller circuitry EC2 is configured to execute pairing between the additional human-powered vehicle component BC2 and another device in the second pairing mode. The second pairing request signal SG21 can be referred to as a pairing request signal SG21.

The second wireless communicator circuitry WC2 is configured to wirelessly receive, in the second pairing mode, the second pairing request signal SG21 generated in response to the second user input U21 of the second input device SW2. The pairing trigger signal TS is distinguishable from the second pairing request signal SG21. The second electronic controller circuitry EC2 is configured to detect the pairing trigger signal TS in the wireless signal listening mode. However, the second electronic controller circuitry EC2 is configured to ignore or not detect the second pairing request signal SG21 in the wireless signal listening mode.

For example, the second pairing request signal SG21 includes an advertisement signal having no specified recipient. The second pairing request signal SG21 can also be referred to as a second advertising signal. The second pairing request signal SG21 includes pairing information ID4 of the second remote component RC2. The fourth electronic controller circuitry EC4 is configured to store the pairing information ID4 in the memory EC42. The pairing information ID4 includes information relating to the second remote component RC2. The pairing information ID4 includes at least one of identification information and cryptographic key information. The identification information includes a unique number indicating the second remote component RC2. Examples of the unique number include an address of the second remote component RC2. The cryptographic key information includes a cryptographic key. Another wireless communicator encrypts information using the cryptographic key information, and the second remote component RC2 decrypts the encrypted information using the cryptographic key information. The cryptographic key information of the pairing information ID4 corresponds to a communication protocol used in the additional human-powered vehicle component BC2 and the second remote component RC2.

The fourth electronic controller circuitry EC4 is configured to wirelessly transmit the second pairing request signal SG21 at predetermined intervals in the fourth pairing mode. The second wireless communicator circuitry WC2 is configured to detect wireless signals such as the second pairing request signal SG21 in the second pairing mode. Thus, the second wireless communicator circuitry WC2 detects the second pairing request signal SG21 in the second pairing mode in a case where the additional human-powered vehicle component BC2 and the second remote component RC2 are in the second pairing mode and the fourth pairing mode, respectively. The second electronic controller circuitry EC2 is configured to store, in the memory EC22, the pairing information ID4 included in the second pairing request signal SG21 in a case where the second wireless communicator circuitry WC2 detects the second pairing request signal SG21 in the second pairing mode.

The second wireless communicator circuitry WC2 is configured to wirelessly transmit a second pairing response signal SG22 in response to the second pairing request signal SG21. The fourth wireless communicator circuitry WC4 of the second remote component RC2 is configured to detect the second pairing response signal SG22 transmitted from the second wireless communicator circuitry WC2 in the fourth pairing mode. The second pairing response signal SG22 can be referred to as a pairing response signal SG22.

The second pairing response signal SG22 includes second pairing information ID2 of the additional human-powered vehicle component BC2. The second electronic controller circuitry EC2 is configured to store the second pairing information ID2 in the memory EC22. The second pairing information ID2 includes at least one of second identification information and second cryptographic key information. In the present embodiment, for example, the second pairing response signal SG22 includes the second identification information of the second pairing information ID2. The second identification information includes a unique number indicating the additional human-powered vehicle component BC2. Examples of the unique number include an address of the additional human-powered vehicle component BC2. The second cryptographic key information includes a second cryptographic key. Another wireless communicator encrypts information using the second cryptographic key information, and the second wireless communicator circuitry WC2 decrypts the encrypted information using the second cryptographic key information. The fourth electronic controller circuitry EC4 is configured to store the second pairing information ID2 in the memory EC32. The second pairing information ID2 can also be referred to as pairing information ID2. The second cryptographic key information corresponds to the communication protocol used in the additional human-powered vehicle component BC2 and the second remote component RC2.

In the present embodiment, the second wireless communicator circuitry WC2 is configured to automatically transmit the second pairing response signal SG22 in response to the second pairing request signal SG21 in the second pairing mode. However, the second wireless communicator circuitry WC2 can be configured to wirelessly transmit a second pairing response signal SG22 based on another trigger other than the second pairing request signal SG21 if needed or desired. For example, the user interface BC21 can be configured to receive a user operation indicating transmission of the second pairing response signal SG22. The second wireless communicator circuitry WC2 can be configured to transmit the second pairing response signal SG22 in response to the user operation in a state where the second wireless communicator circuitry WC2 receives the second pairing request signal SG21.

The fourth wireless communicator circuitry WC4 is configured to detect, in the fourth pairing mode, the second pairing response signal SG22 transmitted from the second wireless communicator circuitry WC2. The fourth electronic controller circuitry EC4 is configured to store, in the memory EC42, the second pairing information ID2 included in the second pairing response signal SG22 in a case where the fourth wireless communicator circuitry WC4 detects the second pairing response signal SG22 in the fourth pairing mode.

Accordingly, the additional human-powered vehicle component BC2 and the second remote component RC2 are paired during the pairing process. The second electronic controller circuitry EC2 can be configured to cause the additional human-powered vehicle component BC2 to exit the second pairing mode and to enter a second control mode after the completion of the pairing process. For example, the second electronic controller circuitry EC2 can be configured to cause the additional human-powered vehicle component BC2 to exit the second pairing mode and to enter the second control mode after the second wireless communicator circuitry WC2 wirelessly transmits the second pairing response signal SG22 in the second pairing mode. In the second control mode, the additional human-powered vehicle component BC2 is controlled based on the second signal CS2 transmitted from the second operating device 26. The second signal CS2 is encrypted by the third wireless communicator circuitry WC3 using the cryptographic key information of the second pairing information ID2. Thus, the additional human-powered vehicle component BC2 can decrypt the encrypted information included in the second signal CS2 while another component, which is not paired with the additional human-powered vehicle component BC2, cannot decrypt the encrypted information included in the second signal CS2.

The second electronic controller circuitry EC2 can be configured to cause the additional human-powered vehicle component BC2 to exit the second pairing mode based on a condition other than the completion of the pairing process. For example, the user interface BC21 can be configured to receive the user operation including a mode reset user input UM2. Namely, the user interface BC21 is configured to receive the mode reset user input UM2. The second electronic controller circuitry EC2 can be configured to cause the additional human-powered vehicle component BC2 to exit the second pairing mode in response to the mode reset user input UM2 received by the user interface BC21. Alternatively, the second electronic controller circuitry EC2 can be configured to cause the additional human-powered vehicle component BC2 to exit the second pairing mode after a predetermined time as elapsed from entering the second pairing mode. In this modification, the second electronic controller circuitry EC2 can be configured to cause the additional human-powered vehicle component BC2 to enter the wireless signal listening mode after exiting the second pairing mode.

The fourth electronic controller circuitry EC4 can be configured to cause the second remote component RC2 to exit the second pairing mode and to enter a fourth control mode after the completion of the pairing process. For example, the fourth electronic controller circuitry EC4 can be configured to cause the second remote component RC2 to exit the fourth pairing mode and to enter the fourth control mode after the fourth wireless communicator circuitry WC4 wirelessly transmits the second pairing request signal SG21 in the fourth pairing mode or after the fourth wireless communicator circuitry WC4 wirelessly receives the second pairing response signal SG22 in the fourth pairing mode. In the fourth control mode, the second remote component RC2 is configured to wirelessly transmit the second signal CS2 to the additional human-powered vehicle component BC2.

Furthermore, the fourth electronic controller circuitry EC4 can be configured to transmit a second pairing signal SG23 via the fourth wireless communicator circuitry WC4 in response to the second pairing response signal SG22 in the fourth pairing mode. The second pairing signal SG23 is generated in response to the second pairing response signal SG22. In this modification, the second wireless communicator circuitry WC2 can be configured to receive the second pairing signal SG23 from the second remote component RC2. The fourth electronic controller circuitry EC4 can be configured to cause the second remote component RC2 to exit the second pairing mode and to enter the fourth control mode after the fourth wireless communicator circuitry WC4 wirelessly transmits the second pairing signal SG23 in the fourth pairing mode. The second electronic controller circuitry EC2 can be configured to cause the additional human-powered vehicle component BC2 to exit the second pairing mode and to enter the second control mode after the second wireless communicator circuitry WC2 wirelessly receives the second pairing signal SG23 in the second pairing mode. The second pairing signal SG23 can also be referred to as a pairing signal SG23.

The fourth electronic controller circuitry EC4 can be configured to cause the second remote component RC2 to exit the fourth pairing mode based on a condition other than the completion of the pairing process. For example, the second input device SW2 can be configured to receive the user operation including a mode reset user input UM4. Namely, the second input device SW2 is configured to receive the mode reset user input UM4. The fourth electronic controller circuitry EC4 can be configured to cause the second remote component RC2 to exit the fourth pairing mode in response to the mode reset user input UM4 received by the second input device SW2. Alternatively, the fourth electronic controller circuitry EC4 can be configured to cause the second remote component RC2 to exit the fourth pairing mode after a predetermined time as elapsed from entering the fourth pairing mode. In this modification, the fourth electronic controller circuitry EC4 can be configured to cause the second remote component RC2 to enter the wireless signal listening mode after exiting the fourth pairing mode.

As seen in FIG. 9, the human-powered vehicle component BC1 further comprises a notification device BC12. The notification device BC12 is configured to be controlled by the first electronic controller circuitry EC1. Here, the notification device BC12 includes a light emitting device. For example, the notification device BC12 includes one or more light emitting diodes (LEDs). Here, the notification device BC12 includes a red LED, a blue LED and a green LED that can be selectively illuminated by the first electronic controller circuitry EC1 to produce different colors of light. In other words, the first electronic controller circuitry EC1 is configured to control the notification device BC12 to selectively illuminate the LEDs of the notification device BC12. The first electronic controller circuitry EC1 is configured to control the notification device BC12 to produce a notification (e.g., a solid continuous light or a flashing light of a predetermined color) indicating that a particular situation is occurring or has been completed.

The notification device BC12 is visible through a transparent window portion of a housing. In a case where the human-powered vehicle component BC1 includes the suspension 16, for example, the notification device BC12 is visible through a transparent window portion of at least one of the first longitudinal member 16A, the second longitudinal member 16B, the power source holder BC16, and another housing.

In one example, the notification device BC12 includes a light emitter BC12A. The light emitter BC12A is configured to emit light. Light emitted from the light emitter BC12A is visible through the transparent window portion. The transparent window portion can include one or more pieces for transmitting the light emitted from the light emitter BC12A to outside of the suspension 16.

As seen in FIG. 9, the first remote component RC1 further comprises a notification device RC12. The notification device RC12 is configured to be controlled by the third electronic controller circuitry EC3. Here, the notification device RC12 includes a light emitting device. For example, the notification device RC12 includes one or more light emitting diodes (LEDs). Here, the notification device RC12 includes a red LED, a blue LED and a green LED that can be selectively illuminated by the third electronic controller circuitry EC3 to produce different colors of light. In other words, the third electronic controller circuitry EC3 is configured to control the notification device RC12 to selectively illuminate the LEDs of the notification device RC12. The third electronic controller circuitry EC3 is configured to control the notification device RC12 to produce a notification (e.g., a solid continuous light or a flashing light of a predetermined color) indicating that a particular situation is occurring or has been completed.

The notification device RC12 is visible through a transparent window portion of a housing. In one example, the notification device RC12 includes a light emitter RC12A. The light emitter RC12A is configured to emit light. Light emitted from the light emitter RC12A is visible through the transparent window portion. The transparent window portion can include one or more pieces for transmitting the light emitted from the light emitter RC12A to outside of the first operating device 24.

As seen in FIG. 10, the additional human-powered vehicle component BC2 further comprises a notification device BC22. The notification device BC22 is configured to be controlled by the second electronic controller circuitry EC2. Here, the notification device BC22 includes a light emitting device. For example, the notification device BC22 includes one or more light emitting diodes (LEDs). Here, the notification device BC22 includes a red LED, a blue LED and a green LED that can be selectively illuminated by the second electronic controller circuitry EC2 to produce different colors of light. In other words, the second electronic controller circuitry EC2 is configured to control the notification device BC22 to selectively illuminate the LEDs of the notification device BC22. The second electronic controller circuitry EC2 is configured to control the notification device BC22 to produce a notification (e.g., a solid continuous light or a flashing light of a predetermined color) indicating that a particular situation is occurring or has been completed.

The notification device BC22 is visible through a transparent window portion of a housing. In a case where the additional human-powered vehicle component BC2 includes the gear changer 12, for example, the notification device BC22 is visible through a transparent window portion of at least one of the base member 12A, the movable member 12B, and another housing.

In one example, the notification device BC22 includes a light emitter BC22A. The light emitter BC22A is configured to emit light. Light emitted from the light emitter BC22A is visible through the transparent window portion. The transparent window portion can include one or more pieces for transmitting the light emitted from the light emitter BC22A to outside of the gear changer 12.

As seen in FIG. 10, the second remote component RC2 further comprises a notification device RC22. The notification device RC22 is configured to be controlled by the fourth electronic controller circuitry EC4. Here, the notification device RC22 includes a light emitting device. For example, the notification device RC22 includes one or more light emitting diodes (LEDs). Here, the notification device RC22 includes a red LED, a blue LED and a green LED that can be selectively illuminated by the fourth electronic controller circuitry EC4 to produce different colors of light. In other words, the fourth electronic controller circuitry EC4 is configured to control the notification device RC22 to selectively illuminate the LEDs of the notification device RC22. The fourth electronic controller circuitry EC4 is configured to control the notification device RC22 to produce a notification (e.g., a solid continuous light or a flashing light of a predetermined color) indicating that a particular situation is occurring or has been completed.

The notification device RC22 is visible through a transparent window portion of a housing. In one example, the notification device RC22 includes a light emitter RC22A. The light emitter RC22A is configured to emit light. Light emitted from the light emitter RC22A is visible through the transparent window portion. The transparent window portion can include one or more pieces for transmitting the light emitted from the light emitter RC22A to outside of the second operating device 26.

As seen in FIG. 9, the first electronic controller circuitry EC1 is configured to reset, in response to a data reset trigger, the human-powered vehicle component BC1 such that pairing information of another component which has been stored in the memory EC12 is erased. The data reset trigger includes at least one of: an operation of the user interface BC11; and a data reset signal transmitted from another device such as the trigger input device TG, the additional human-powered vehicle component BC2, the first remote component RC1, and the second remote component RC2. For example, the user interface BC11 is configured to receive the user operation indicating reset of pairing information. Namely, the user interface BC11 is configured to receive a data reset user input UD1. The first electronic controller circuitry EC1 is configured to reset, in response to the data reset user input UD1, the human-powered vehicle component BC1 such that the pairing information (e.g., the pairing information ID3) of another component which has been stored in the memory EC12 is erased.

Furthermore, the trigger input device TG can be configured to receive the data reset user input UD1. The trigger input device TG can be configured to wirelessly transmit a data reset signal DS1. The first electronic controller circuitry EC1 can be configured to reset, in response to the data reset signal DS1, the human-powered vehicle component BC1 such that the pairing information (e.g., the pairing information ID3) of another component which has been stored in the memory EC12 is erased.

The trigger input device TG can be used to set a pass code using software (application) in the trigger input device TG. When a pass code is set, a user cannot enable reset operation without using the pass code. In the case where the trigger input device TG is a smartphone or a tablet computer, the reset interface of the trigger input device TG can be the touch screen. Also, the first electronic controller circuitry EC1 can be configured to disable the reset operation based on a command from at least one of the trigger input device TG, the additional human-powered vehicle component BC2, the first remote component RC1, and the second remote component RC2.

As seen in FIG. 10, the second electronic controller circuitry EC2 is configured to reset, in response to a data reset trigger, the additional human-powered vehicle component BC2 such that pairing information of another component which has been stored in the memory EC22 is erased. The data reset trigger includes at least one of: an operation of the user interface BC21; and a data reset signal transmitted from another device such as the trigger input device TG, the additional human-powered vehicle component BC2, the second remote component RC2, and the second remote component RC2. For example, the user interface BC21 is configured to receive the user operation indicating reset of pairing information. Namely, the user interface BC21 is configured to receive a data reset user input UD2. The second electronic controller circuitry EC2 is configured to reset, in response to the data reset user input UD2, the additional human-powered vehicle component BC2 such that the pairing information (e.g., the pairing information ID4) of another component which has been stored in the memory EC22 is erased.

Furthermore, the trigger input device TG can be configured to receive the data reset user input UD2. The trigger input device TG can be configured to wirelessly transmit a data reset signal DS2. The second electronic controller circuitry EC2 can be configured to reset, in response to the data reset signal DS2, the additional human-powered vehicle component BC2 such that the pairing information (e.g., the pairing information ID4) of another component which has been stored in the memory EC22 is erased.

The second electronic controller circuitry EC2 can be configured to disable the reset operation based on a command from at least one of the trigger input device TG, the additional human-powered vehicle component BC2, the first remote component RC1, and the second remote component RC2.

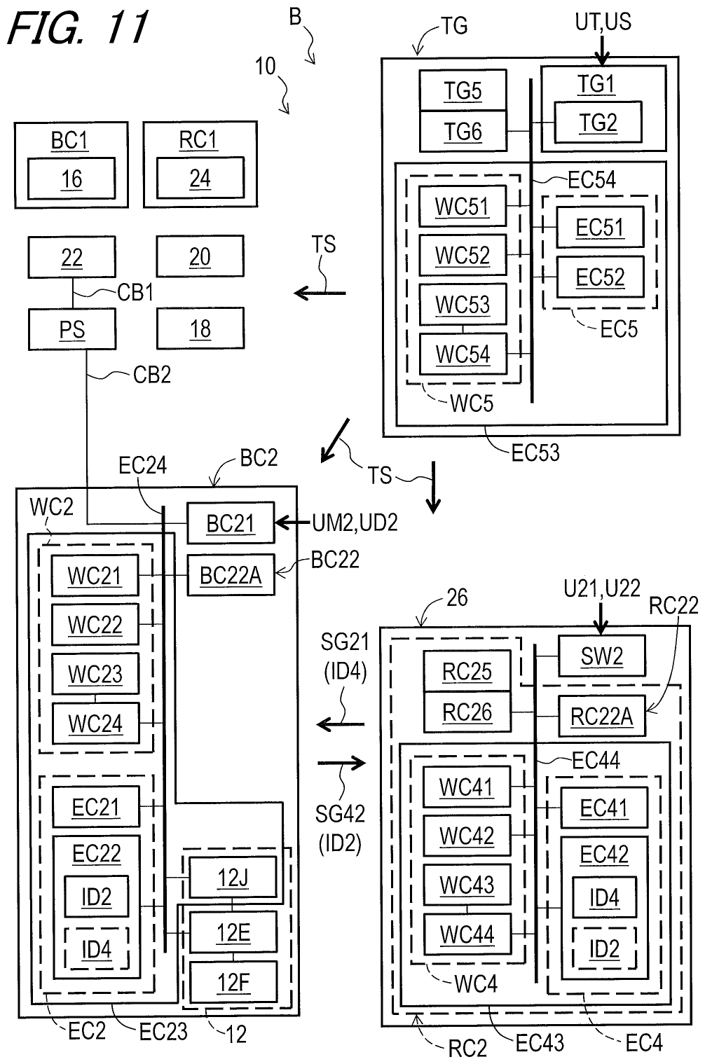

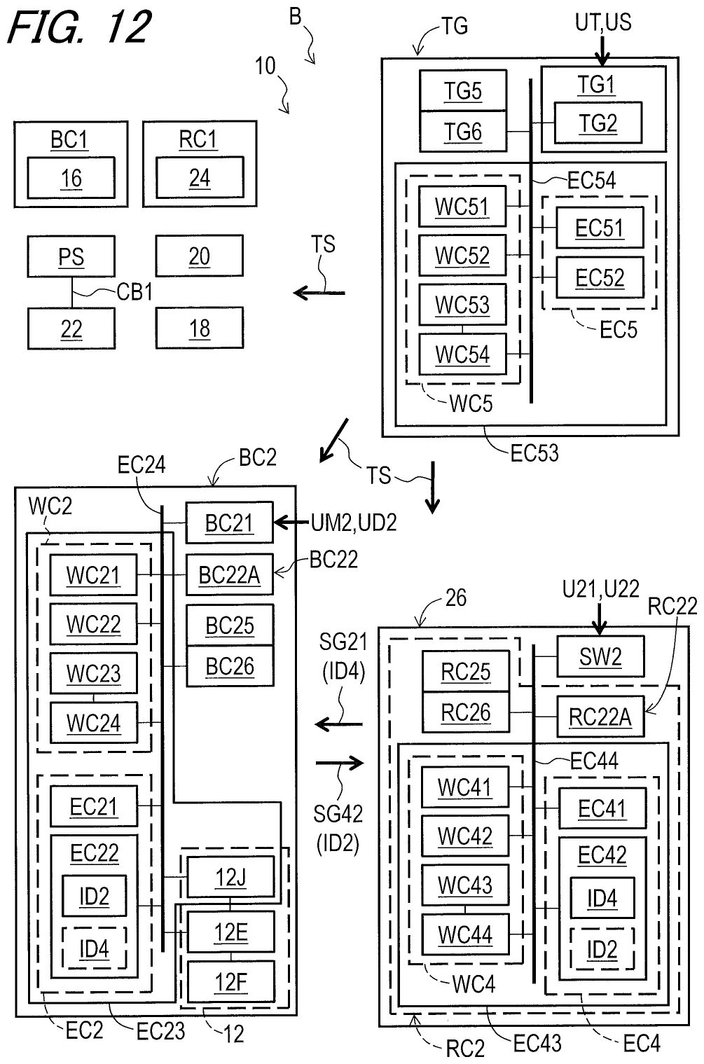

As seen in FIG. 11, the electrical power source PS can be directly connected to the additional human-powered vehicle component BC2 by the second electrical cable CB2 if needed or desired. Alternatively, as seen in FIG. 12, the additional human-powered vehicle component BC2 can include an electrical power source BC25 and a power source holder BC26. The electrical power source BC25 is configured to supply electrical power to the second electronic controller circuitry EC2, the second wireless communicator circuitry WC2, and other electronic parts of the additional human-powered vehicle component BC2. The electrical power source BC25 is configured to supply electrical power to the electric actuator 12E, the actuator driver 12F, and other electronic parts of the gear changer 12. The power source holder BC26 is configured to detachably and reattachably hold the electrical power source BC25. The electrical power source BC25 is configured to be detachably and reattachably attached to the power source holder BC26. The power source holder BC26 is configured to be electrically connected to the second electronic controller circuitry EC2, the second wireless communicator circuitry WC2, and other electronic parts of the additional human-powered vehicle component BC2. The power source holder BC26 is configured to be electrically connected to the electric actuator 12E, the actuator driver 12F, and other electronic parts of the gear changer 12. The electrical power source BC25 is configured to supply electrical power to the second electronic controller circuitry EC2, the second wireless communicator circuitry WC2, and other electronic parts of the additional human-powered vehicle component BC2 via the power source holder BC26. The electrical power source BC25 is configured to supply electrical power to the electric actuator 12E, the actuator driver 12F, and other electronic parts of the gear changer 12 via the power source holder BC26. Examples of the electrical power source BC25 includes a primary battery and a secondary battery.

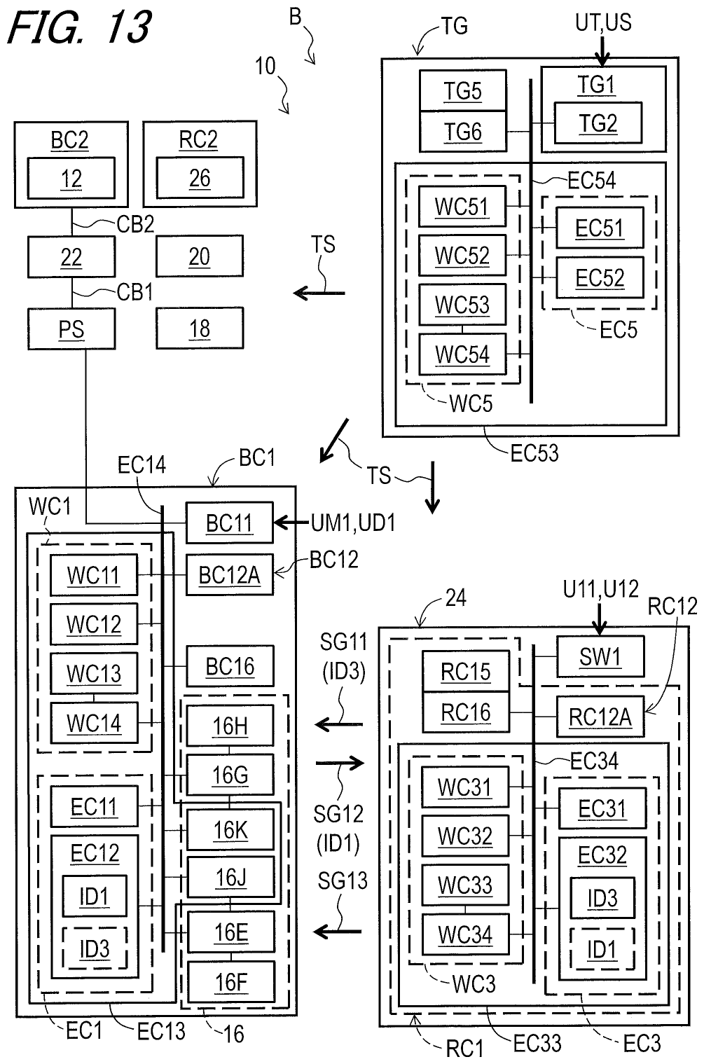

As seen in FIG. 13, the human-powered vehicle component BC1 can be configured to be electrically connected to the electrical power source PS if needed or desired. In such modifications, the electrical power source BC15 can be replaced with a dummy member held by the power source holder BC16 if needed or desired. The electrical power source BC15 and the power source holder BC16 can be omitted from the human-powered vehicle component BC1 if needed or desired.

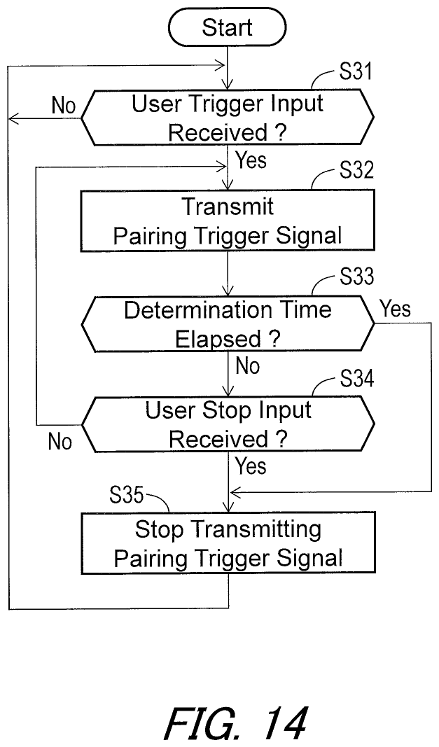

Referring now to FIGS. 14 to 16, the pairing process executed between the human-powered vehicle component BC1 and the first remote component RC1 will be discussed below. The pairing process of FIGS. 14 to 16 can be used in each of the human-powered vehicle control systems 10 and the modifications thereof. The pairing process of FIGS. 14 to 16 can be used to execute the pairing process between at least two of the at least two human-powered vehicle components BC.

In step S31, as seen in FIG. 14, the fifth electronic controller circuitry EC5 of the trigger input device TG determines whether the trigger input device TG receives the user trigger input UT. The fifth electronic controller circuitry EC5 determines whether the touch panel TG2 of the display TG1 receives the user trigger input UT. For example, the fifth electronic controller circuitry EC5 controls the display TG1 to display information relating to whether to cause a human-powered vehicle component to enter a pairing mode or whether to send the pairing trigger signal TS.

In step S32, the fifth electronic controller circuitry EC5 controls the fifth wireless communicator circuitry WC5 to wirelessly transmit the pairing trigger signal TS in response to the user trigger input UT. For example, the fifth electronic controller circuitry EC5 controls the fifth wireless communicator circuitry WC5 to wirelessly transmit the pairing trigger signal TS in a case where the user selects the pairing mode of the human-powered vehicle component or the transmission of the pairing trigger signal TS.

In step S33, the fifth electronic controller circuitry EC5 determines whether a determination time elapses from the detection of the user trigger input UT. In step S35, the fifth electronic controller circuitry EC5 controls the fifth wireless communicator circuitry WC5 to stop transmitting the pairing trigger signal TS in a case where the determination time elapsed.

In step S34, the fifth electronic controller circuitry EC5 determines whether the trigger input device TG receives a user stop input US in a case where the determination time has not elapsed. In step S35, the fifth electronic controller circuitry EC5 controls the fifth wireless communicator circuitry WC5 to stop transmitting the pairing trigger signal TS in a case where the trigger input device TG receives the user stop input US via the touch panel TG2 of the display TG1. In steps S34 and S32, the fifth electronic controller circuitry EC5 controls the fifth wireless communicator circuitry WC5 to wirelessly transmit the pairing trigger signal TS in a case where the trigger input device TG has not received the user stop input US via the touch panel TG2 of the display TG1.

As discussed above referring to FIG. 14, the non-transitory computer-readable storage medium EC52 stores program for causing the trigger input device TG including the display TG1 to execute a method comprising: receiving the user trigger input UT; and transmitting wirelessly, in response to the user trigger input UT, the pairing trigger signal TS to cause the human-powered vehicle component BC1 to enter the first pairing mode. In the present embodiment, the receiving the user trigger input UT includes receiving the user trigger input UT via the touch panel TG2. However, the receiving the user trigger input UT can include receiving the user trigger input UT via a device other than the touch panel TG2 if needed or desired.

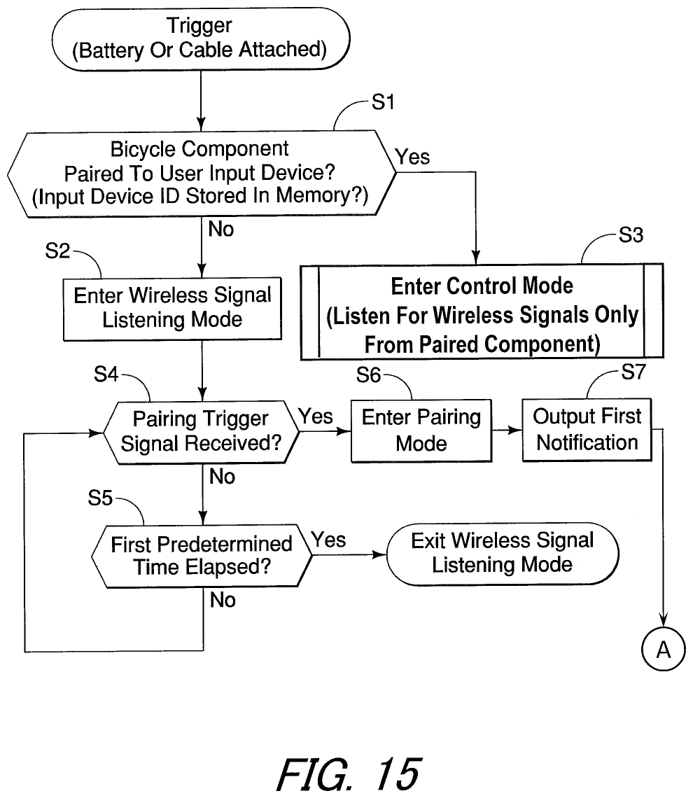

As seen in FIG. 15, the human-powered vehicle component BC1 starts when a triggering event occurs. In other words, the first electronic controller circuitry EC1 causes the human-powered vehicle component BC1 to enter the wireless signal listening mode in response to the trigger. Here, the trigger is when the human-powered vehicle component BC1 receives electrical power. The trigger includes at least one of: providing electrical power to the human-powered vehicle component BC1; connecting an electrical power source to the human-powered vehicle component BC1; connecting an electrical cable connected to the additional human-powered vehicle component BC2; operating an additional control device configured to control the additional human-powered vehicle component BC2; and providing the output from the sensor to the human-powered vehicle component BC1. For example, in one case, the trigger can occur when a battery is attached to the human-powered vehicle component BC1 either directly or indirectly such that the electrical power is provided to the human-powered vehicle component BC1.

In another case, for example, the trigger can occur when the second electrical cable CB2 is connected to one of the assist drive unit 22 and the electrical power source PS and then connected to the human-powered vehicle component BC1 (see e.g., FIG. 13). In another case, for example, the trigger can occur when the user interface BC11 of the human-powered vehicle component BC1 is operated to turn on (i.e., supply power from the electrical power source PS) the human-powered vehicle component BC1.

In any case, in the present embodiments, the notification device BC12 is not activated (e.g., an LED is not illuminated) when the human-powered vehicle component BC1 receives electrical power. Now, once the human-powered vehicle component BC1 receives electrical power, the first electronic controller circuitry EC1 proceeds to step S1.

In step S1, the first electronic controller circuitry EC1 first determines whether the human-powered vehicle component BC1 has already been paired to another component such as the additional human-powered vehicle component BC2, the first remote component RC1, and the second remote component RC2. In particular, after the electrical power is supplied to the human-powered vehicle component BC1, the first electronic controller circuitry EC1 reads the memory EC12 to determine whether pairing information (e.g., identification information) of another component is stored in the memory EC12. In a case where the human-powered vehicle component BC1 has not been paired to another component, then the first electronic controller circuitry EC1 proceeds to step S2 where the first electronic controller circuitry EC1 controls the human-powered vehicle component BC1 to enter the wireless signal listening mode. In other words, in a case where pairing information (e.g., identification information) of a remote component has not been stored in the memory EC12, then the first electronic controller circuitry EC1 controls the first wireless communicator circuitry WC1 such that the human-powered vehicle component BC1 enters the wireless signal listening mode. On the other hand, in a case where the human-powered vehicle component BC1 has been paired to another component, then the first electronic controller circuitry EC1 proceeds to step S3 where the first electronic controller circuitry EC1 controls the first wireless communicator circuitry WC1 to enter the first control mode and the pairing process ends. In other words, in a case where pairing information of another component is already stored in the memory EC12, then the first electronic controller circuitry EC1 controls the first wireless communicator circuitry WC1 such that the human-powered vehicle component BC1 enters the first control mode instead of the wireless signal listening mode.

Accordingly, the first electronic controller circuitry EC1 is configured to prohibit the human-powered vehicle component BC1 from entering the wireless signal listening mode in a state where wireless communication between the human-powered vehicle component BC1 and another component is established.

In step S2, the first electronic controller circuitry EC1 controls the first wireless communicator circuitry WC1 to enter the wireless signal listening mode. In the wireless signal listening mode, the first wireless communicator circuitry WC1 monitors or listens for all wireless signals from all types of components that can transmit a wireless signal according to the wireless protocol of the human-powered vehicle component BC1. Thus, the phrase “wireless signal listening mode” refers to a mode where the human-powered vehicle component BC1 or another human-powered vehicle component has not completed a pairing operation. The first wireless communicator circuitry WC1 wirelessly receives the pairing trigger signal TS transmitted from the trigger input device TG in the wireless signal listening mode.

For example, the first electronic controller circuitry EC1 controls the first wireless communicator circuitry WC1 to operate intermittently in a state where the human-powered vehicle component BC1 is in the wireless signal listening mode. Also, as mentioned above, the first signal amplifier WC14 operates in the first low power consumption state (i.e., a lower power consumption state than the first high power consumption state of the first pairing mode) in a state where the human-powered vehicle component BC1 is in the wireless signal listening mode. After entering the wireless signal listening mode, the first electronic controller circuitry EC1 proceeds to step S4.

In step S2, when pairing information (e.g., identification information) of another component is not already stored in the memory EC12, the first electronic controller circuitry EC1 controls the first wireless communicator circuitry WC1 such that first wireless communicator circuitry WC1 communicates when the first wireless communicator circuitry WC1 receives a wireless signal regardless of the pairing information included in the signal. That is, the human-powered vehicle component BC1 enters the wireless signal listening mode.

In step S3, in a case where the pairing information of a remote component has been stored in the memory EC12, the first electronic controller circuitry EC1 controls the first wireless communicator circuitry WC1 such that the first wireless communicator circuitry WC1 communicates with the first electronic controller circuitry EC1 only when the first wireless communicator circuitry WC1 receives the signal from the paired remote component.

That is, in the case where the pairing information of the first remote component RC1 is stored in the memory EC12, the human-powered vehicle component BC1 enters the first control mode so that the first remote component RC1 becomes the paired remote component. In the case where the pairing information of the second remote component RC2 is stored in the memory EC12, the human-powered vehicle component BC1 enters the first control mode so that the second remote component RC2 becomes the paired remote component. In the first control mode, the first wireless communicator circuitry WC1 stores the pairing information of the paired remote component in the memory EC12. Thus, in the first control mode, the first electronic controller circuitry EC1 determines whether a wireless signal should be processed or not, by comparing the pairing information included in the wireless signal with the pairing information of the paired remote component stored in the memory EC12.

In step S4, the first electronic controller circuitry EC1 controls the first wireless communicator circuitry WC1 to listen for the pairing trigger signal TS. More specifically, in a case where the trigger input device TG wirelessly transmits the pairing trigger signal TS at predetermined intervals in response to the user trigger input UT of the trigger input device TG, the first wireless communicator circuitry WC1 wirelessly receives the pairing trigger signal TS in the wireless signal listening mode. The trigger input device TG can be any device that can generate a wireless signal that is compatible with the communications protocol of the first wireless communicator circuitry WC1. In other words, the trigger input device TG can include at least one of the user interface BC21 of the additional human-powered vehicle component BC2, the first input device SW1, the first remote component RC1, the second input device SW2, and the second remote component RC2. In the present embodiment, at least one of the user interface BC21 of the additional human-powered vehicle component BC2, the first input device SW1, the first remote component RC1, the second input device SW2, and the second remote component RC2 can be used as the trigger input device TG to generate the pairing trigger signal TS.

Preferably, in step S4, the first electronic controller circuitry EC1 is configured to cause the human-powered vehicle component BC1 to enter the first pairing mode in response to the pairing trigger signal TS in a state where pairing information of another component is not stored in the memory EC12. The human-powered vehicle component BC1 can be controlled to perform the pairing process when no pairing information is stored in the memory EC12.

In step S4, the first electronic controller circuitry EC1 determines whether the wireless signal is the pairing trigger signal TS or not (e.g., whether the first wireless communicator circuitry WC1 wirelessly receives the pairing trigger signal TS). In a case where the pairing trigger signal TS is not received, then the pairing process proceeds to step S5. On the other hand, in a case where the pairing trigger signal TS is received, then the pairing process proceeds to step S6.

In step S5, the first electronic controller circuitry EC1 determines whether a first predetermined time (e.g., one to three seconds) has elapsed from entering the wireless signal listening mode. If the first predetermined time has not elapsed, then the pairing process proceeds back to step S4 to continue to listen for the pairing trigger signal TS. In a case where the first predetermined time has elapsed from entering the wireless signal listening mode, then the pairing process ends. In other words, the first electronic controller circuitry EC1 controls the human-powered vehicle component BC1 to exit the wireless signal listening mode. In this way, the first electronic controller circuitry EC1 causes the human-powered vehicle component BC1 to exit the wireless signal listening mode after the first predetermined time as elapsed from entering the wireless signal listening mode. Step S5 can be omitted if needed or desired. Specifically, step S5 can be omitted where the first wireless communicator circuitry WC1 operates intermittently in the wireless signal listening mode and/or where the first signal amplifier WC14 operates in the first low power consumption state in the wireless signal listening mode.

In step S6, the first electronic controller circuitry EC1 causes the human-powered vehicle component BC1 to enter the first pairing mode in response to the pairing trigger signal TS received by the first wireless communicator circuitry WC1. In other words, in step S6, the first electronic controller circuitry EC1 causes the human-powered vehicle component BC1 to exit the wireless signal listening mode and to enter the first pairing mode in response to the pairing trigger signal TS received by the first wireless communicator circuitry WC1. In this way, the pairing process begins. Next, the pairing process proceeds to step S7.

In step S7, the first electronic controller circuitry EC1 activates the notification device BC12 to produce a first notification in response to entrance of the human-powered vehicle component BC1 to the first pairing mode. For example, the blue LED of the notification device BC12 can start flashing in a 0.5 second cycle during the first pairing mode. Next, the pairing process proceeds to step S8.

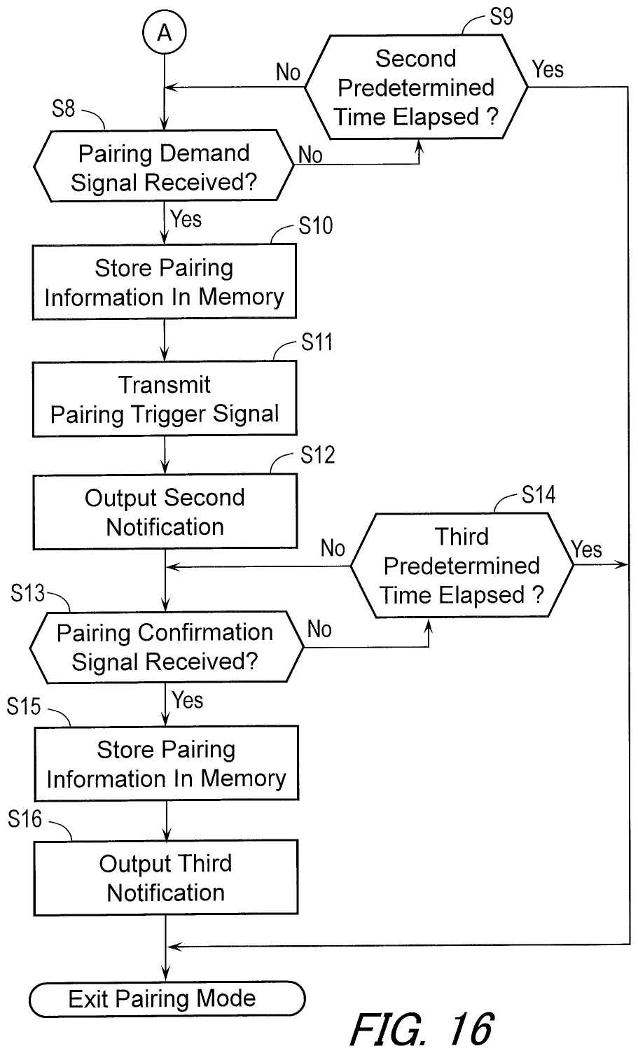

As seen in FIG. 16, in step S8, the first electronic controller circuitry EC1 controls the first wireless communicator circuitry WC1 to listen for a pairing request signal. More specifically, the first wireless communicator circuitry WC1 wirelessly receives the first pairing request signal SG11 generated in response to the first user input U11 of the first input device SW1. Here, in the illustrated example, the first remote component RC1 is configured to generate the first pairing request signal SG11 in the third pairing mode of the first remote component RC1. However, alternatively, the second remote component RC2 can be used to generate the first pairing request signal SG11 in the fourth pairing mode of the second remote component RC2. In other words, the first pairing request signal SG11 is generated by an input device of a remote component that is desired to be paired with the human-powered vehicle component BC1.

In step S8, in a case where a pairing request signal is not received, then the pairing process proceeds to step S9. On the other hand, in a case where the first pairing request signal SG11 is received, then the first electronic controller circuitry EC1 establishes wireless communication between the human-powered vehicle component BC1 and the first remote component RC1 that sent the first pairing request signal SG11 in a state where the human-powered vehicle component BC1 is in the first pairing mode, and the pairing process proceeds to step S10.

In step S9, the first electronic controller circuitry EC1 determines whether a second predetermined time (e.g., two to three seconds) has elapsed. If the second predetermined time has not elapsed, then the pairing process proceeds back to step S8 to continue to listen for a pairing request signal. In a case where the second predetermined time has elapsed, the first electronic controller circuitry EC1 controls the human-powered vehicle component BC1 to exit the first pairing mode, then the pairing process ends. Step S9 can be omitted if needed or desired. Specifically, step S9 can be omitted where the first wireless communicator circuitry WC1 operates intermittently in the first pairing mode and/or the first signal amplifier WC14 operates in the first low power consumption state in the first pairing mode.

In step S10, the first electronic controller circuitry EC1 stores the pairing information ID3 included in the first pairing request signal SG11 in the memory EC12. Here, as mentioned above, the pairing information ID3 identifies the first remote component RC1. Thus, the wireless signal generated by the third wireless communicator circuitry WC3 includes the pairing information ID3, which is received by the first wireless communicator circuitry WC1 so that the first electronic controller circuitry EC1 can determine the source of the wireless signal as being from the third wireless communicator circuitry WC3 of the first remote component RC1. In step S10, for example, the first electronic controller circuitry EC1 stores the identification information of the pairing information ID3 included in the first pairing request signal SG11 in the memory EC12. At this point, the notification device BC12 is not illuminated. However, the first wireless communicator circuitry WC1 can transmit an acknowledgement signal to the third wireless communicator circuitry WC3 upon receiving and storing the pairing information ID3. The first remote component RC1 can produce a notification to the user. For example, the first remote component RC1 can illuminate an LED of the notification device RC12 to notify a user that the pairing information (e.g., identification information) has been received and stored in the memory EC12. Next, the pairing process proceeds to step S11.

In step S11, the first electronic controller circuitry EC1 controls the first wireless communicator circuitry WC1 to wirelessly transmit the first pairing response signal SG12 in response to the first pairing request signal SG11. The first pairing response signal SG12 includes the pairing information ID1 of the human-powered vehicle component BC1. The first pairing response signal SG12 can be encrypted using the pairing information ID3 included in the first pairing request signal SG11. The first remote component RC1 wirelessly receives the first pairing response signal SG12. In the first remote component RC1, the third electronic controller circuitry EC3 stores, in the memory EC32, the pairing information ID1 included in the first pairing response signal SG12. Next, the pairing process proceeds to step S12.

In step S12, the first electronic controller circuitry EC1 activates the notification device BC12 to produce a second notification in a state where the human-powered vehicle component BC1 has been successfully paired. The phrase “successfully paired” as used herein refers a situation in which the pairing information (e.g., identification information) has been stored in the memory EC12. Preferably, the second notification is different from the first notification. For example, where the first notification is a flashing blue light, the second notification can be a solid color light of any color, or a flashing light other than a blue light. Next, the pairing process proceeds to step S13.

In step S13, to confirm that the human-powered vehicle component BC1 has been paired to the first remote component RC1, the first electronic controller circuitry EC1 determines whether the pairing signal SG13 has been received. In the present embodiment, the third electronic controller circuitry EC3 controls the third wireless communicator circuitry WC3 to wirelessly transmit the pairing signal SG13 in response to the first pairing response signal SG12. Alternatively, the pairing signal SG13 can be generated in response to a user input to the first input device SW1 provided on the first remote component RC1 that is being paired. To generate the pairing signal SG13, for example, the first input device SW1 can be depressed for a predetermined amount of time such as 0.5 second or more.

In a case where the pairing signal SG13 has not received in step S13, then the pairing process proceeds to step S14. In step S14, the first electronic controller circuitry EC1 determines whether a third predetermined time (e.g., two to three seconds) has elapsed after the start of step S13. If the third predetermined time has not elapsed from the start of step S13, then the pairing process proceeds back to step S13 to continue to listen for the pairing signal SG13. In a case where the third predetermined time has elapsed from the start of step S13 without detecting a pairing signal, the first electronic controller circuitry EC1 controls the human-powered vehicle component BC1 to exit the first pairing mode, then the pairing process ends. In a case where a pairing signal has received in step S13 before the third predetermined time elapses, the pairing process proceeds to step S15.

In step S15, the first electronic controller circuitry EC1 stores the pairing information ID3 included in the first pairing signal SG13 in the memory EC12. Here, as mentioned above, the pairing information ID3 identifies the first remote component RC1. Thus, the wireless signal generated by the third wireless communicator circuitry WC3 includes the pairing information ID3, which is received by the first wireless communicator circuitry WC1 so that the first electronic controller circuitry EC1 can determine the source of the wireless signal as being from the third wireless communicator circuitry WC3 of the first remote component RC1. Furthermore, the pairing information ID3 includes the cryptographic key information with which a signal is encrypted. In step S15, for example, the first electronic controller circuitry EC1 stores the cryptographic key information or both the identification information and the cryptographic key information of the pairing information ID3 included in the first pairing signal SG13 in the memory EC12. However, step S15 or both the step S14 and S15 can be omitted from the flowchart of the pairing process. In such modifications, the first pairing request signal SG11 includes the pairing information ID3 including both the identification information and the cryptographic key information of the first remote component RC1. In step S10, the the first electronic controller circuitry EC1 stores, in the memory EC12, both the identification information and the cryptographic key information which are included in the pairing information ID3 included in the first pairing request signal SG11. The first wireless communicator circuitry WC1 can transmit an acknowledgement signal to the third wireless communicator circuitry WC3 upon receiving and storing the pairing information ID3. Next, the pairing process proceeds to step S16.

In step S16, the first electronic controller circuitry EC1 activates the notification device BC12 to produce a third notification in response the completion of the first pairing mode for establishing wireless communication between the human-powered vehicle component BC1 and at least one remote component. The phrase “establishing wireless communication” used herein refers a situation in which the memory EC12 stores at least one pairing information (e.g., identification information). That is, the phrase “establishing wireless communication” as used herein refers a situation in which the human-powered vehicle component BC1 has exited the first pairing mode and has entered the first control mode so that the human-powered vehicle component BC1 can be operated by the paired remote component having the pairing information stored in the memory EC12.

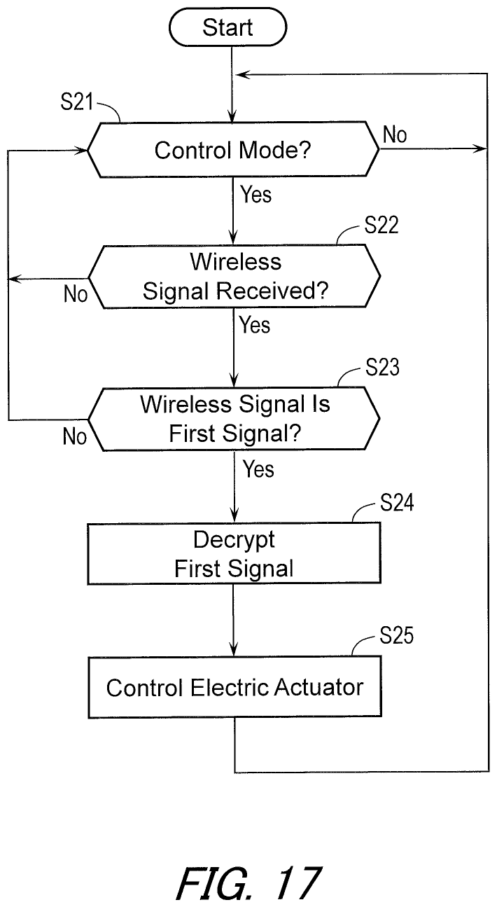

Referring now to FIG. 17, a control process will now be discussed where the human-powered vehicle component BC1 is operated using the first remote component RC that has been paired to the human-powered vehicle component BC1. This control process will be explained based the case where the human-powered vehicle component BC1 includes the suspension 16 and where the human-powered vehicle component BC1 has been paired with the first remote component RC1. However, the control process can be used with other components.

In this control process of FIG. 17, the control process can be a separate control process or a subroutine of step S3 of FIG. 15. Basically, the first wireless communicator circuitry WC1 wirelessly receives the first signal CS1 which is encrypted based on the pairing information ID1 stored in the memory EC32 of the third electronic controller circuitry EC3. In other words, in the illustrated examples, the first wireless communicator circuitry WC1 of the human-powered vehicle component BC1 is configured to wirelessly receive the first signal CS1 including the pairing information from the third wireless communicator circuitry WC3 of the first remote component RC1.

In step S21 of the control process of FIG. 17, the first electronic controller circuitry EC1 first determines whether the human-powered vehicle component BC1 is in the first control mode. In a case where the human-powered vehicle component BC1 has not entered the first control mode, then the control process of FIG. 17 ends. In a case where the first electronic controller circuitry EC1 concludes that the human-powered vehicle component BC1 has entered the first control mode, then the control process proceeds to step S22.

In step S22, the first electronic controller circuitry EC1 determines whether the first wireless communicator circuitry WC1 receives a wireless signal. In step S23, in a case where the first wireless communicator circuitry WC1 detects the wireless signal, the first electronic controller circuitry EC1 determines whether the wireless signal is the first signal CS1 which is encrypted using the pairing information ID1 of the human-powered vehicle component BC1. In step S23, for example, the first electronic controller circuitry EC1 determines whether the pairing information included in the wireless signal is the same as the pairing information ID stored in the memory EC12 of the first electronic controller circuitry EC1. In a case where the pairing information of the wireless signal is different from the pairing information ID, the control process returns to step S21. In steps S23 and S24, for example, in a case where the pairing information of the wireless signal is the same as the pairing information ID, the first electronic controller circuitry EC1 decrypts the encrypted information included in the wireless signal (e.g., the first signal CS1) using the cryptographic key information of the pairing information ID1, then the control process proceeds to step S25.

In step S25, the first electronic controller circuitry EC1 controls the electric actuator 16E or 16G of the suspension 16 via the actuator driver 16J or 16K based on the first signal CS1. In a case where the first signal CS1 indicates changing the damping property of the suspension 16, the first electronic controller circuitry EC1 controls the electric actuator 16E to actuate the state changing structure 16F via the actuator driver 16J based on the first signal CS1. In a case where the first signal CS1 indicates changing the stroke of the suspension 16, the first electronic controller circuitry EC1 controls the electric actuator 16E to actuate the state changing structure 16F via the actuator driver 16J based on the first signal CS1. The control process returns to step S21. Accordingly, the first electronic controller circuitry EC1 is configured to control the human-powered vehicle component BC1 in accordance with a control signal including the first pairing information ID1 stored in the memory EC12.

The pairing process illustrated in FIGS. 14 to 16 can be modified such that the pairing process can be stopped by at anytime by the user. For example, the user interface BC11 can be operated by a user at anytime to exit the pairing process. In other words, the user can exit the first pairing mode using the user interface BC11. When the user exits the first pairing mode using the user interface BC11 prior to receiving a pairing signal, all of the identification information stored in the memory EC12 will be cleared from the memory EC12.

The pairing process illustrated in FIGS. 14 to 16 can be applied to the pairing process executed between another human-powered vehicle component (e.g., the additional human-powered vehicle component BC2) and another remote component (e.g., the second remote component RC2). The pairing process illustrated in FIGS. 14 to 16 can be applied to the pairing process executed between the human-powered vehicle component BC1 and another remote component (e.g., the second remote component RC2). The pairing process illustrated in FIGS. 14 to 16 can be applied to the pairing process executed between another human-powered vehicle component (e.g., the additional human-powered vehicle component BC2) and the first remote component RC1.

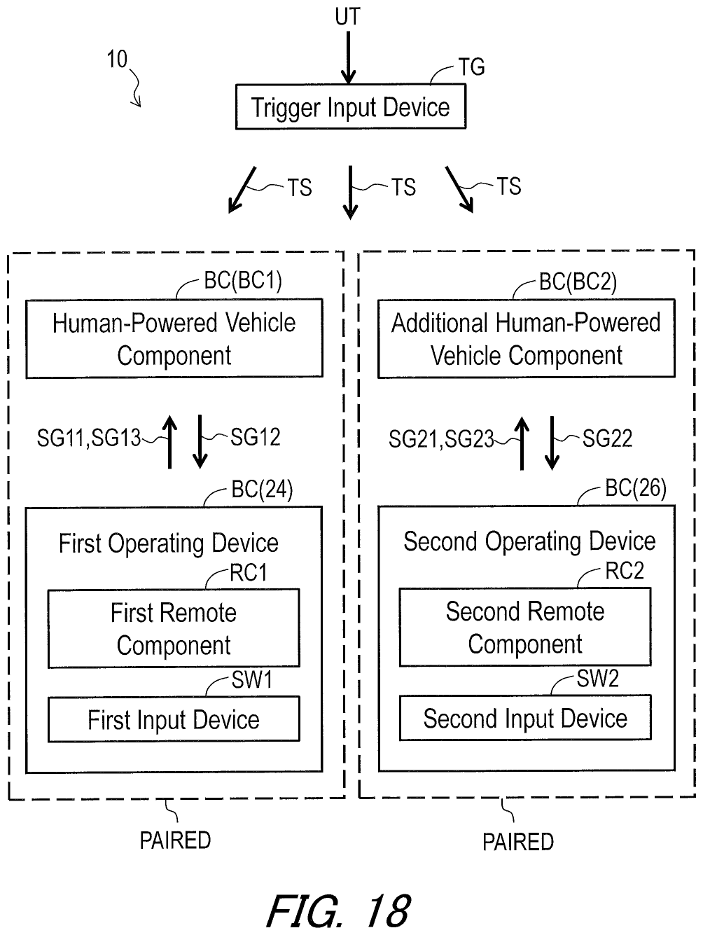

As seen in FIG. 18, the trigger input device TG is configured to transmit the pairing trigger signal TS in response to the user trigger input UT to at least two of the at least two human-powered vehicle components BC. The trigger input device TG is configured to transmit the pairing trigger signal TS in response to the user trigger input UT to at least two of the human-powered vehicle component BC1, the additional human-powered vehicle component BC2, the first remote component RC1, and the second remote component RC2. For example, the trigger input device TG is configured to transmit the pairing trigger signal TS in response to the user trigger input UT to the human-powered vehicle component BC1 and the additional human-powered vehicle component BC2. In a state where both the human-powered vehicle component BC1 and the additional human-powered vehicle component BC2 are in the wireless signal listening mode, the first electronic controller circuitry EC1 controls the human-powered vehicle component BC1 to enter the first pairing mode in response to the pairing trigger signal TS while the second electronic controller circuitry EC2 controls the additional human-powered vehicle component BC2 to enter the second pairing mode in response to the pairing trigger signal TS. The human-powered vehicle component BC1 and the additional human-powered vehicle component BC2 can enter the pairing mode in response to the pairing trigger signal TS. The total number of the human-powered vehicle components BC which enters the pairing mode in response to the pairing trigger signal TS is not limited to two. At least three of the human-powered vehicle components BC can enter the pairing mode in response to the pairing trigger signal TS. Furthermore, in the modification depicted in FIG. 18, the additional human-powered vehicle component BC2 and the second operating device 26 can be installed in a human-powered vehicle other than the human-powered vehicle B illustrate in FIG. 1 while the human-powered vehicle component BC1 and the first operating device 24 are installed in the human-powered vehicle B. Accordingly, the pairing process can be easily executed between at least two sets of human-powered vehicle components, executing the pairing process efficiently even if there are some or many human-powered vehicle components.

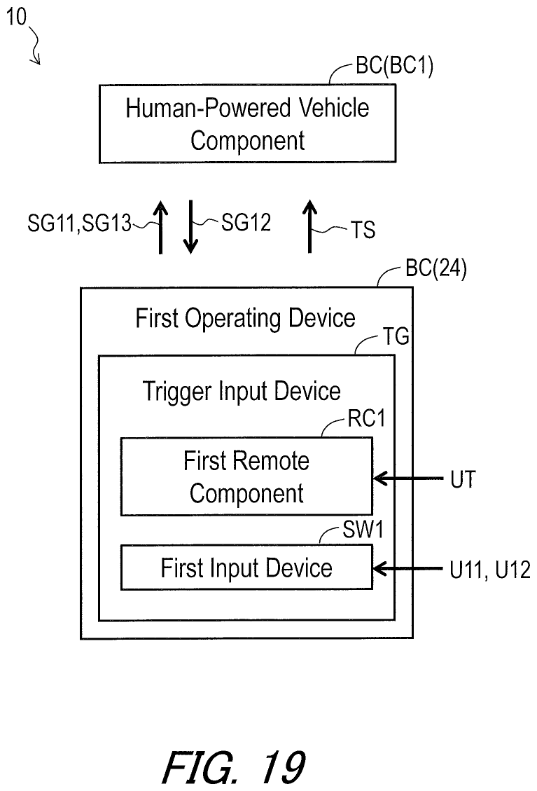

In the above-mentioned embodiments and the modifications thereof, the trigger input device TG is provided separately from both the first remote component RC1 and the first input device SW1. As seen in FIG. 19, however, the trigger input device TG can include at least one of the first remote component RC1 and the first input device SW1 if needed or desired. In the modification depicted in FIG. 19, the trigger input device TG includes both the first remote component RC1 and the first input device SW1. The first operating device 24 includes the trigger input device TG. In the modification of FIG. 19, the first operating device 24 includes the display TG1 in a case where the trigger input device TG includes the display TG1. However, the display TG1 can be omitted from the trigger input device TG and the first operating device 24. Examples of the user trigger input UT include a long press of the touch panel TG2 and a long press of at least one switch provided as the first input device SW1. In a case where the first input device SW1 includes at least two switches, examples of the user trigger input UT include a simultaneous long press of the at least two switches of the first input device SW1.

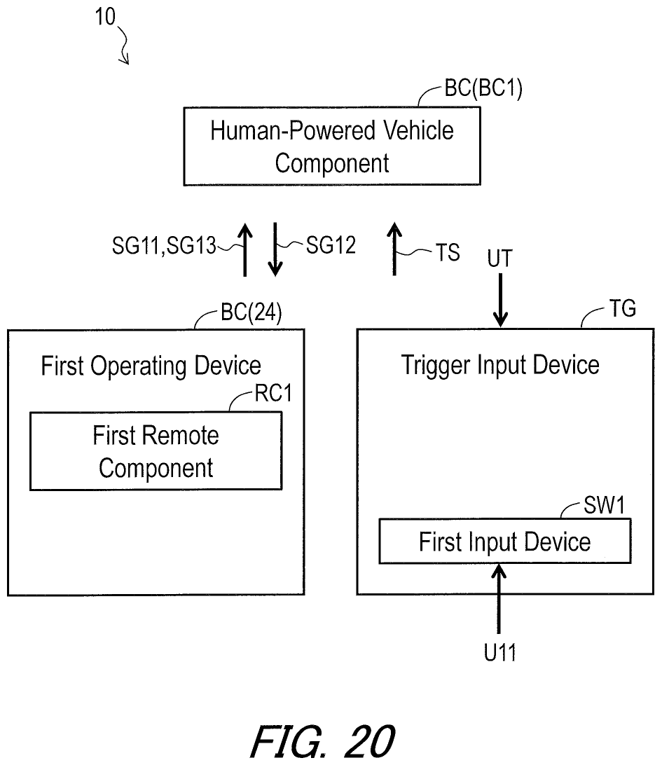

As seen in FIG. 20, the trigger input device TG can include only the first input device SW1 among the first input device SW1 and the first remote component RC1. In the modification depicted in FIG. 20, the first input device SW1 of the trigger input device TG can be configured to receive the user trigger input UT if needed or desired. The trigger input device TG and the first input device SW1 are electrically connected to the first remote component RC1 via an electric cable. In the modification of FIG. 20, the display TG1 can be omitted from the trigger input device TG if needed or desired. Examples of the user trigger input UT include a long press of the touch panel TG2 and a long press of at least one switch provided as the first input device SW1. In a case where the first input device SW1 includes at least two switches, examples of the user trigger input UT include a simultaneous long press of the at least two switches of the first input device SW1.

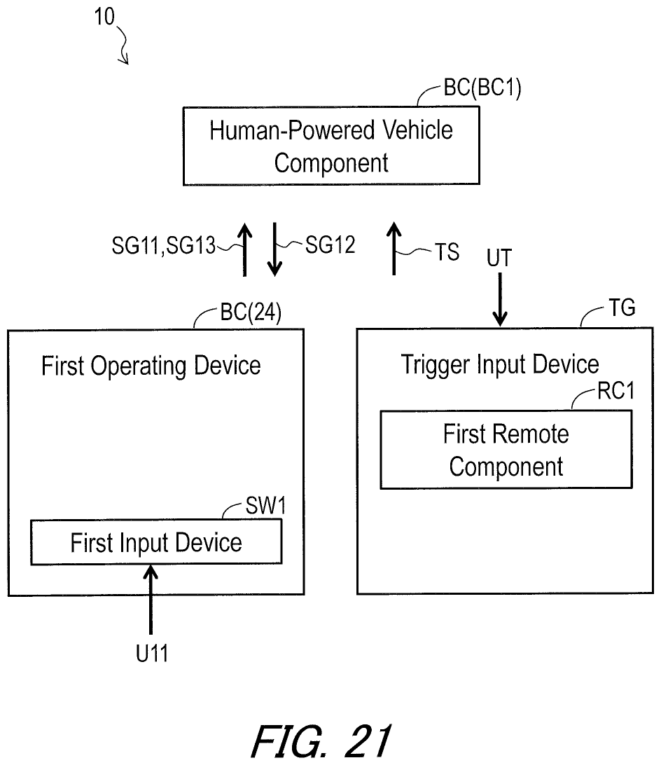

As seen in FIG. 21, the trigger input device TG can include only the first remote component RC1 among the first input device SW1 and the first remote component RC1. In the modification depicted in FIG. 21, the trigger input device TG and the first remote component RC1 are electrically connected to the first input device SW1 via an electric cable. In the modification of FIG. 21, the display TG1 can be omitted from the trigger input device TG if needed or desired. Examples of the user trigger input UT include a long press of the touch panel TG2 and a long press of at least one switch provided as the first input device SW1. In a case where the first input device SW1 includes at least two switches, examples of the user trigger input UT include a simultaneous long press of the at least two switches of the first input device SW1.

In the pairing process illustrated in FIGS. 14 to 16, the notification device BC12 outputs the first notification, the second notification, and the third notification in steps S7, S12, and S16. However, at least one of the first to third notifications can be omitted from the pairing process if needed or desired.

In the pairing process illustrated in FIGS. 14 to 16, the human-powered vehicle component BC1 wirelessly receives the first pairing signal SG13 in step S13 after transmitting the first pairing response signal SG12. However, steps S13 and S14 can be omitted from the pairing process if needed or desired.

While the present disclosure focused on the pairing executed between the human-powered vehicle component BC1 including the suspension 16 and the first operating device 24 including the first remote component RC1 and the first input device SW1, the pairing process can be applied to any other human-powered vehicle components and remote components equipped with wireless communications. For example, the suspension 18 can be provided with wireless communicator circuitry that is paired with wireless communicator circuitry of a remote component (e.g., the first remote component RC1 or the second remote component RC2) so that the remote component can wirelessly communicate with the suspension 18 to adjust settings of the suspension 18. Likewise, for example, the adjustable seatpost 20 can be provided with wireless communicator circuitry that is paired with wireless communicator circuitry of a remote component (e.g., the first remote component RC1 or the second remote component RC2) so that the remote component can wirelessly communicate with the adjustable seatpost 20 to adjust settings of the adjustable seatpost 20. Furthermore, for example, the assist drive unit 22 can be provided with wireless communicator circuitry that is paired with wireless communicator circuitry of a remote component (e.g., the first remote component RC1 or the second remote component RC2) so that the remote component can wirelessly communicate with the assist drive unit 22 to adjust settings of the assist drive unit 22.

In the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. This concept also applies to words of similar meaning, for example, the terms “have,” “include” and their derivatives.

The terms “member,” “section,” “portion,” “part,” “element,” “body” and “structure” when used in the singular can have the dual meaning of a single part or a plurality of parts.

The ordinal numbers such as “first” and “second” recited in the present application are merely identifiers, but do not have any other meanings, for example, a particular order and the like. Moreover, for example, the term “first element” itself does not imply an existence of “second element,” and the term “second element” itself does not imply an existence of “first element.”

The term “pair of,” as used herein, can encompass the configuration in which the pair of elements have different shapes or structures from each other in addition to the configuration in which the pair of elements have the same shapes or structures as each other.

The terms “a” (or “an”), “one or more” and “at least one” can be used interchangeably herein.

The phrase “at least one of” as used in this disclosure means “one or more” of a desired choice. For one example, the phrase “at least one of” as used in this disclosure means “only one single choice” or “both of two choices” if the number of its choices is two. For other example, the phrase “at least one of” as used in this disclosure means “only one single choice” or “any combination of equal to or more than two choices” if the number of its choices is equal to or more than three. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Finally, terms of degree such as “substantially,” “about” and “approximately” as used herein mean a reasonable amount of deviation of the modified term such that the end result is not significantly changed. All of numerical values described in the present application can be construed as including the terms such as “substantially,” “about” and “approximately.”

Obviously, numerous modifications and variations of the present invention are possible in light of the above teachings. It is therefore to be understood that within the scope of the appended claims, the invention may be practiced otherwise than as specifically described herein.

What is claimed is:

1. A human-powered vehicle component comprising:
first wireless communicator circuitry configured to wirelessly receive a pairing trigger signal generated in response to a user trigger input of a trigger input device, the trigger input device including a display; and
first electronic controller circuitry configured to cause the human-powered vehicle component to enter a first pairing mode in response to the pairing trigger signal.

2. The human-powered vehicle component according to claim 1, wherein
the first wireless communicator circuitry is configured to wirelessly receive, in the first pairing mode, a first pairing request signal generated in response to a first user input of a first input device, and
the first electronic controller circuitry is configured to establish, in the first pairing mode, wireless communication between the human-powered vehicle component and a first remote component that sent the first pairing request signal.

3. The human-powered vehicle component according to claim 1, wherein
the trigger input device has a function other than a function relating to the human-powered vehicle.

4. The human-powered vehicle component according to claim 1, wherein
the trigger input device is provided separately from at least one of the first remote component and the first input device.

5. The human-powered vehicle component according to claim 1, wherein
the trigger input device includes at least one of the first remote component and the first input device.

6. The human-powered vehicle component according to claim 1, wherein
the pairing trigger signal is distinguishable from the first pairing request signal.

7. The human-powered vehicle component according to claim 1, wherein
the first wireless communicator circuitry is configured to wirelessly transmit a first pairing response signal in response to the first pairing request signal.

8. The human-powered vehicle component according to claim 7, wherein
the first wireless communicator circuitry is configured to automatically transmit the first pairing response signal in response to the first pairing request signal.

9. The human-powered vehicle component according to claim 7, further comprising:
a user interface configured to receive a user operation,
the first wireless communicator circuitry being configured to transmit the first pairing response signal in response to the user operation in a state where the first wireless communicator circuitry receives the first pairing request signal.

10. The human-powered vehicle component according to claim 7, wherein
the first wireless communicator circuitry is configured to receive a first pairing signal from the first remote component, and
the first pairing signal is generated in response to the first pairing response signal.

11. The human-powered vehicle component according to claim 1, wherein
the human-powered vehicle component has a wireless signal listening mode in which the first electronic controller circuitry detects the pairing trigger signal via the first wireless communicator circuitry, and
the wireless signal listening mode is different from the first pairing mode.

12. The human-powered vehicle component according to claim 11, wherein
the first electronic controller circuitry is configured to cause the human-powered vehicle component to enter the first pairing mode in a case where the first electronic controller circuitry detects the pairing trigger signal via the first wireless communicator circuitry in the wireless signal listening mode.

13. The human-powered vehicle component according to claim 11, wherein
the first wireless communicator circuitry is configured to wirelessly receive, in the first pairing mode, a first pairing request signal generated in response to a first user input of a first input device, and
the first electronic controller circuitry is configured to ignore or not detect the first pairing request signal in the wireless signal listening mode.

14. The human-powered vehicle component according to claim 11, wherein
the first electronic controller circuitry is configured to cause, in response to a trigger, the human-powered vehicle component to enter the wireless signal listening mode.

15. The human-powered vehicle component according to claim 14, wherein
the trigger includes at least one of:
providing electrical power to the human-powered vehicle component;
connecting an electrical power source to the human-powered vehicle component;
connecting an electrical cable connected to an additional human-powered vehicle component;
operating an additional control device configured to control the additional human-powered vehicle component; and
providing an output from a sensor to the human-powered vehicle component.

16. The human-powered vehicle component according to claim 1, wherein
the trigger input device includes at least one of a smartphone, a tablet computer, a personal computer, a wearable device, and a cycle computer, and
the first wireless communicator circuitry is configured to wirelessly receive the pairing trigger signal generated in response to the user trigger input received by the at least one of the smartphone, the tablet computer, the personal computer, the wearable device, and the cycle computer.

17. A human-powered vehicle control system comprising:
the human-powered vehicle component according to claim 1; and
the first remote component.

18. The human-powered vehicle control system according to claim 17, further comprising:
an additional human-powered vehicle component comprising:
second wireless communicator circuitry configured to wirelessly receive the pairing trigger signal generated in response to the user trigger input; and
second electronic controller circuitry configured to cause the additional human-powered vehicle component to enter a second pairing mode in response to the pairing trigger signal.

19. The human-powered vehicle control system according to claim 18, wherein
the trigger input device is configured to transmit the pairing trigger signal in response to the user trigger input to the human-powered vehicle component and the additional human-powered vehicle component.

20. A human-powered vehicle control system comprising:
a human-powered vehicle component comprising first wireless communicator circuitry and first electronic controller circuitry, the first wireless communicator circuitry being configured to wirelessly receive a pairing trigger signal generated in response to a user trigger input of a trigger input device, the first electronic controller circuitry being configured to cause the human-powered vehicle component to enter a first pairing mode in response to the pairing trigger signal; and
an additional human-powered vehicle component comprising second wireless communicator circuitry and second electronic controller circuitry, the second wireless communicator circuitry being configured to wirelessly receive the pairing trigger signal, the second electronic controller circuitry being configured to cause the additional human-powered vehicle component to enter a second pairing mode in response to the pairing trigger signal.

21. The human-powered vehicle control system according to claim 20, wherein
the first wireless communicator circuitry is configured to wirelessly receive, in the first pairing mode, a first pairing request signal generated in response to a first user input of a first input device, and
the first electronic controller circuitry is configured to establish, in the first pairing mode, wireless communication between the human-powered vehicle component and a first remote component that sent the first pairing request signal.

22. The human-powered vehicle control system according to claim 18, wherein
the second wireless communicator circuitry is configured to wirelessly receive, in the second pairing mode, a second pairing request signal generated in response to a second user input of a second input device, and
the second electronic controller circuitry is configured to establish, in the second pairing mode, wireless communication between the additional human-powered vehicle component and a second remote component that sent the second pairing request signal.

23. A non-transitory computer-readable storage medium storing program for causing a trigger input device including a display to execute a method comprising:
receiving a user trigger input; and
transmitting wirelessly, in response to the user trigger input, a pairing trigger signal to cause a human-powered vehicle component to enter a first pairing mode.

24. The non-transitory computer-readable storage medium according to claim 23, wherein
the display includes a touch panel configured to receive the user trigger input, and
the receiving the user trigger input includes receiving the user trigger input via the touch panel.
